(19) United States
(12) Patent Application Publication
(10) Pub. No.: US 2026/0277627 A1
(43) Pub. Date: Sep. 17, 2026

(54) INFORMATION PUSH METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Qi YE, Shenzhen (CN); Jun ZHAO, Shenzhen (CN); Zichun QIN, Shenzhen (CN); Feng WANG, Shenzhen (CN)

(21) Appl. No.: 19/673,462

(22) Filed: May 11, 2026

Related U.S. Application Data
(63) Continuation of application No. PCT/CN2025/080421, filed on Mar. 4, 2025.

(30) Foreign Application Priority Data
Mar. 25, 2024 (CN) 202410341747.7

(51) Int. Cl. G06F 9/448; G06N 5/022; H04L 67/55

(52) U.S. Cl. CPC G06F 9/449; G06N 5/022; H04L 67/55

(57) ABSTRACT

An information push method includes: obtaining an interaction item identifier sequence, the interaction item identifier sequence including interaction item identifiers of a user; obtaining an interaction item feature sequence and an interaction behavior feature sequence based on the interaction item identifier sequence; fusing the interaction item feature sequence and the interaction behavior feature sequence to obtain a fused feature sequence, and extracting autocorrelation information of fused features in the fused feature sequence to obtain an autocorrelation feature sequence; and identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, the enhanced feature sequence being configured for implementing item information push.

### CROSS-REFERENCES TO RELATED APPLICATIONS

This application is a continuation application of PCT Patent Application No. PCT/CN2025/080421, filed on Mar. 4, 2025, which claims priority to Chinese Patent Application No. 2024103417477, filed on Mar. 25, 2024, all of which is incorporated herein by reference in their entirety.

### FIELD OF THE TECHNOLOGY

The present disclosure relates to the field of artificial intelligence technologies, and in particular, to an information push method and apparatus, a computer device, a storage medium, and a computer program product.

### BACKGROUND OF THE DISCLOSURE

With the development of the artificial intelligence technology, information push technology has emerged. This technology enables extraction of user representations, and whether to perform information delivery is determined by calculating a similarity between the user representation and representations of to-be-pushed information.

Currently, when extracting user representations, historical behavior information of the user is usually obtained to extract an embedding representation of the user. However, accuracy of the embedding representation of the user that is extracted by using the historical behavior information of the user is relatively low, which can easily lead to reduced accuracy of information push, and consequently result in a waste of push resources.

### SUMMARY

One embodiment of the present disclosure provides an information push method including: obtaining an interaction item identifier sequence, the interaction item identifier sequence comprising interaction item identifiers of a user; obtaining an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong; fusing the interaction item feature sequence and the interaction behavior feature sequence to obtain a fused feature sequence, and extracting autocorrelation information of fused features in the fused feature sequence to obtain an autocorrelation feature sequence; and identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, the enhanced feature sequence being configured for predicting interaction degrees respectively corresponding to preset candidate item identifiers, and performing item information push based on the interaction degrees respectively corresponding to the preset candidate item identifiers.

Another embodiment of the present disclosure provides a computer device including one or more processors and a memory containing a computer program that, when been executed, causes the one or more processors to perform: obtaining an interaction item identifier sequence, the interaction item identifier sequence comprising interaction item identifiers of a user; obtaining an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong; fusing the interaction item feature sequence and the interaction behavior feature sequence to obtain a fused feature sequence, and extracting autocorrelation information of fused features in the fused feature sequence to obtain an autocorrelation feature sequence; and identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, the enhanced feature sequence being configured for predicting interaction degrees respectively corresponding to preset candidate item identifiers, and performing item information push based on the interaction degrees respectively corresponding to the preset candidate item identifiers.

Another embodiment of the present disclosure provides a non-transitory computer-readable storage medium containing a computer program, that when been executed, causes at least one processor to perform: obtaining an interaction item identifier sequence, the interaction item identifier sequence comprising interaction item identifiers of a user; obtaining an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong; fusing the interaction item feature sequence and the interaction behavior feature sequence to obtain a fused feature sequence, and extracting autocorrelation information of fused features in the fused feature sequence to obtain an autocorrelation feature sequence; and identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, the enhanced feature sequence being configured for predicting interaction degrees respectively corresponding to preset candidate item identifiers, and performing item information push based on the interaction degrees respectively corresponding to the preset candidate item identifiers.

### BRIEF DESCRIPTION OF THE DRAWINGS

To describe technical solutions of embodiments of the present disclosure more clearly, the following briefly introduces drawings required for describing the embodiments. Apparently, the drawings in the following descriptions are merely some embodiments of the present disclosure, and for those skilled in the art, other drawings may be obtained according to these drawings without creative work.

FIG. 1 is a diagram of an application environment of an information push method according to one embodiment of the present disclosure.

FIG. 2 is a schematic flowchart of an information push method according to one embodiment of the present disclosure.

FIG. 3 is a schematic diagram of a network architecture of a large language model according to one embodiment of the present disclosure.

FIG. 4 is a schematic flowchart of obtaining an enhanced feature sequence according to one embodiment of the present disclosure.

FIG. 5 is a schematic flowchart of obtaining an enhanced feature sequence according to another embodiment of the present disclosure.

FIG. 6 is a schematic diagram of a network architecture for obtaining an enhanced feature sequence according to an embodiment of the present disclosure.

FIG. 7 is a schematic diagram of a network architecture of a sparse mixture-of-experts network according to an embodiment of the present disclosure.

FIG. 8 is a diagram of a network architecture for obtaining a depth enhanced feature sequence according to an embodiment of the present disclosure.

FIG. 9 is a schematic diagram of a model architecture of an information push model according to an embodiment of the present disclosure.

FIG. 10 is a schematic principle diagram of an information push method according to an embodiment of the present disclosure.

FIG. 11 is a schematic flowchart of an information push method according to an embodiment of the present disclosure.

FIG. 12 is a structural block diagram of an information push apparatus according to an embodiment of the present disclosure.

FIG. 13 is a diagram of an internal structure of a computer device according to an embodiment of the present disclosure.

FIG. 14 is a diagram of an internal structure of a computer device according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings and the embodiments. Specific embodiments described herein are only intended to explain the present disclosure, and are not intended to limit the present disclosure.

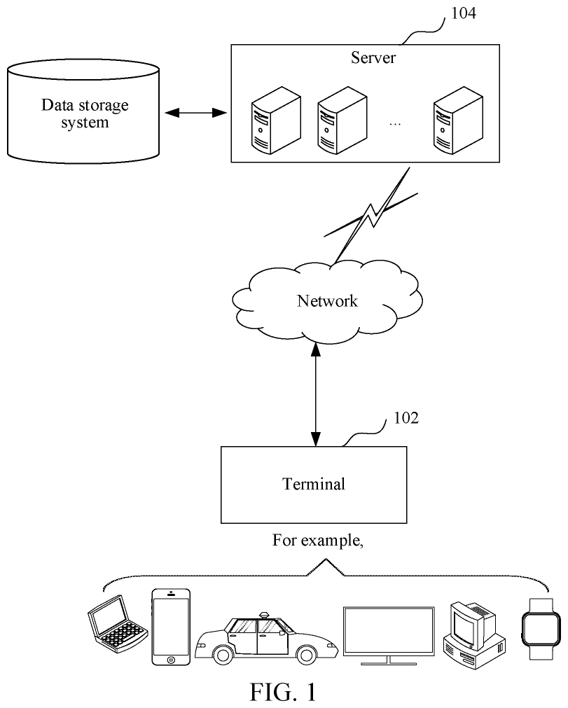

An information push method provided in the embodiments of the present disclosure may be applied to an application environment shown in FIG. 1. A terminal 102 communicates with a server 104 over a network. A data storage system may store data that the server 104 needs to process. A data storage system may be separately set up, or may be integrated on the server 104, or may be placed on a cloud or another server. The server 104 may receive an information push request sent by the terminal 102 of a user, and obtain an interaction item identifier sequence according to the information push request, the interaction item identifier sequence including interaction item identifiers of the user; the server 104 obtains an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong; the server 104 fuses the interaction item feature sequence and the interaction behavior feature sequence to obtain a fused feature sequence, and extracting autocorrelation information of fused features in the fused feature sequence to obtain an autocorrelation feature sequence; the server 104 identifies, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence; and the server uses the enhanced feature sequence to predict interaction degrees respectively corresponding to preset candidate item identifiers, and performs item information push to the terminal 102 of the user based on the interaction degrees respectively corresponding to the preset candidate item identifiers. The terminal may be, but is not limited to, various desktop computers, notebook computers, smartphones, tablet computers, Internet of Things devices, and portable wearable devices. The Internet of Things device may be smart a speaker, a smart television, a smart air conditioner, a smart in-vehicle device, and the like. The portable wearable device may be a smartwatch, a smart band, a head mounted device, or the like. The server may be an independent physical server, or may be a server cluster composed of a plurality of physical servers or a distributed system, and may further be a cloud server providing a cloud computing service. The terminal and the server may be directly or indirectly connected in a wired or wireless communication manner. This is not limited herein in the present disclosure.

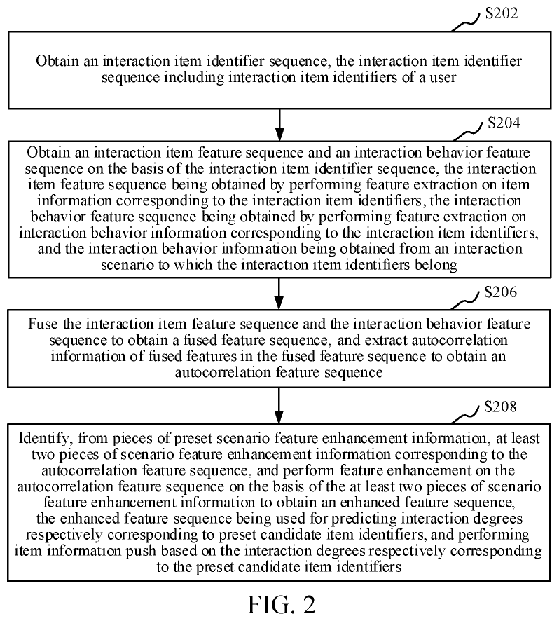

In an embodiment, as shown in FIG. 2, an information push method is provided. An example in which the method is applied to the server in FIG. 1 is configured for description. The method may also be applied to a terminal, or may be applied to a system including a terminal and a server, and is implemented through interaction between the terminal and the server. In this embodiment, the method includes the following operations:

S202: Obtain an interaction item identifier sequence, the interaction item identifier sequence including interaction item identifiers of a user.

The interaction item identifier is configured for uniquely identifying an interaction item. The interaction item refers to an item on which the user performs an interaction behavior. The interaction behavior refers to a behavior in which the user interacts with item information of the item. The interaction behavior may be various operations performed by the user on the item information, which includes, but is not limited to, browsing the item information by the user, clicking the item information by the user, commenting the item information by the user, forwarding the item information by the user, and the like. The interaction item identifier sequence is a sequence formed by interaction item identifiers of the user, for example, may be a sequence formed by identity documents (ID) of interaction items of the user. A sequence order of the interaction item identifier sequence may be determined according to a sequence of interaction between the user and the item information. That is, an interaction item identifier on which an interaction behavior occurs earlier is in the front of the sequence, and an interaction item identifier on which an interaction behavior occurs later is in the rear of the sequence. The sequence order of the interaction item identifier sequence may alternatively be determined according to the number of times of interaction between the user and the item information. That is, an interaction item identifier with a larger number of times of interaction is earlier in the sequence order of the interaction item identifier sequence, and an interaction item identifier with a smaller number of times of interaction is later in the sequence order of the interaction item identifier sequence. The sequence order of the interaction item identifier sequence may alternatively be manually set.

Specifically, the server may directly obtain the interaction item identifier sequence from a database. The server may alternatively obtain the interaction item identifier sequence from a serving party providing an information push service. The server may alternatively obtain the interaction item identifier sequence uploaded by the terminal. The server may alternatively obtain the interaction item identifier sequence from a serving party providing a data service. The server may alternatively obtain the interaction item identifiers of the user, and then sort the interaction item identifiers, to obtain the interaction item identifier sequence. For example, the server may obtain, from a database, the interaction item identifiers of the user and an interaction time point corresponding to each interaction item identifier, and then the server sorts the interaction item identifiers according to an order of the interaction time points, to obtain the interaction item identifier sequence. For another example, the server may obtain, from a database, the interaction item identifiers of the user and importance corresponding to each interaction item identifier, and then the server sorts the interaction item identifiers according to an order of the importance, to obtain the interaction item identifier sequence. For still another example, the server may obtain, from a database, the interaction item identifiers of the user and a quantity of times of interaction corresponding to each interaction item identifier, and then the server sorts the interaction item identifiers according to an order of the quantities of times of interaction, to obtain the interaction item identifier sequence.

S204: Obtain an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong.

The interaction item feature sequence is a sequence formed by the interaction item features of the user. The interaction item feature is configured for representing an interaction item of the user, and is obtained by performing feature extraction on item information corresponding to an interaction item identifier. The item information is information configured for describing the interaction item corresponding to the interaction item identifier. The item information may be multi-modal information, for example, may be item information including at least one of a picture, text, and audio. The interaction behavior feature sequence is a sequence formed by the interaction behavior features of the user. The interaction behavior feature is configured for representing an interaction behavior of the user on an interaction item, and is obtained by performing feature extraction on interaction behavior information corresponding to an interaction item identifier. The interaction behavior information is information configured for describing an interaction behavior of the user on an interaction item, and may be text information. For example, the interaction behavior information may be text information describing that a click operation is performed on item information of the interaction item. That is, the interaction behavior information may be “click item A”. The interaction scenario is a specific scenario for presenting item information of an interaction item, and may be, for example, a client scenario, a web page end scenario, or a mobile phone end scenario. In different interaction scenarios, a same interaction behavior may interact with an interaction item in different manners. For example, in scenario 1, an interaction manner of a click behavior on an interaction item may be performing interaction by touching and holding a corresponding button. In scenario 2, an interaction manner of a click behavior on an interaction item may be performing interaction by sliding a corresponding button. A same interaction item may obtain different interaction behavior information in different interaction scenarios. For example, interaction behavior information of the item A may be “The item A is clicked in scenario 1” and “The item A is clicked in scenario 2”. The sequence order of the interaction item feature sequence and the sequence order of the interaction behavior feature sequence are consistent with the sequence order of the interaction item identifier sequence. For example, the first interaction item feature in the interaction item feature sequence corresponds to the first interaction item identifier in the interaction item identifier sequence, and the first interaction behavior feature in the interaction behavior feature sequence corresponds to the first interaction item identifier.

Specifically, the server may obtain a corresponding interaction item feature according to each interaction item identifier in the interaction item identifier sequence, to obtain an interaction item feature sequence. The server may obtain item information of all items in advance, then perform feature extraction on the item information of all the items, to obtain item features of all the items, and may save the item features of all the items. Then, the server finds a corresponding item feature in item features of the database according to the interaction item identifiers in the interaction item identifier sequence, so as to obtain an interaction item feature of each interaction item identifier. The server may alternatively obtain item information of each interaction item identifier from the database, and then perform feature extraction on the item information of each interaction item identifier, to obtain an interaction item feature of each interaction item identifier. The server may alternatively obtain the interaction item feature of each interaction item identifier sent by the serving party providing the information push service.

The server may simultaneously obtain the interaction behavior features corresponding to the interaction item identifiers, to obtain the interaction behavior feature sequence. The server may collect, from the interaction scenario to which the interaction item identifiers belong, the interaction behavior information of the user for the item information of the interaction item identifiers, and then perform feature extraction on the interaction behavior information of each interaction item identifier, to obtain an interaction behavior feature of each interaction item identifier. The server may alternatively obtain the interaction behavior feature of each interaction item identifier from the serving party providing the information push service. Alternatively, the server may find the interaction behavior feature of each interaction item identifier from the database.

S206: Fuse the interaction item feature sequence and the interaction behavior feature sequence to obtain a fused feature sequence, and extract autocorrelation information of fused features in the fused feature sequence to obtain an autocorrelation feature sequence.

The fused feature sequence includes fused features of the interaction item identifiers, and a fused feature is obtained by fusing an interaction item feature and an interaction behavior feature that are of a same interaction item identifier. The autocorrelation feature sequence includes autocorrelation features. An autocorrelation feature is obtained by extracting autocorrelation information of a fused feature. The autocorrelation information is configured for representing a correlation between different positions in a fused feature sequence. That is, the autocorrelation feature includes related semantic information between different positions in the fused feature.

Specifically, the server separately fuses each interaction item feature in the interaction item feature sequence with the corresponding interaction behavior feature in the interaction behavior feature sequence, to obtain a fused feature sequence. The fusion may be performing linear summation, performing weighted summation, or performing a vector operation on a feature vector, for example, calculating a vector sum or calculating a vector product. Then, the server extracts the autocorrelation information of the fused feature in the fused feature sequence by using an autocorrelation extraction parameter, to obtain the autocorrelation feature sequence. The autocorrelation extraction parameter may be preset or may be obtained through training. For example, the autocorrelation extraction parameter may be a neural network parameter obtained after training on a neural network is completed.

S208: Identify, from pieces of preset scenario feature enhancement information, at least two pieces of scenario feature enhancement information corresponding to the autocorrelation feature sequence, and perform feature enhancement on the autocorrelation feature sequence based on the at least two pieces of scenario feature enhancement information to obtain an enhanced feature sequence. The enhanced feature sequence is configured for predicting interaction degrees respectively corresponding to preset candidate item identifiers, and performing item information push based on the interaction degrees respectively corresponding to the preset candidate item identifiers.

The preset scenario feature enhancement information is preset feature enhancement information of an interaction scenario. The predicted scenario feature enhancement information is information for performing feature enhancement on an autocorrelation feature in the autocorrelation feature sequence, and may include a feature enhancement parameter. The feature enhancement parameter may be obtained through pre-training, or may be determined through a test, or may be a network parameter in the neural network. Semantic information of a corresponding interaction scenario included in the autocorrelation feature sequence can be enhanced by using the scenario feature enhancement information, and semantic expression of different scenarios in the autocorrelation feature sequence can be enhanced by using different scenario feature enhancement information. The enhanced feature sequence includes enhancement features. The enhanced feature sequence is configured for representing a corresponding user. The enhanced feature sequence may be used as an embedding representation of the user for subsequent task processing, for example, information push prediction may be performed, classification may be performed, and the like.

Specifically, the server calculates correlation degrees between pieces of preset scenario feature enhancement information and the autocorrelation feature sequence, and then selects at least two pieces of scenario feature enhancement information corresponding to the autocorrelation feature sequence from the pieces of preset scenario feature enhancement information according to the correlation degrees between the pieces of preset scenario feature enhancement information and the autocorrelation feature sequence. The selected at least two pieces of scenario feature enhancement information are scenario feature enhancement information most correlated to the autocorrelation feature sequence. Then, feature enhancement is performed on the autocorrelation feature sequence by using the at least two pieces of scenario feature enhancement information. The autocorrelation feature sequence may be enhanced by using each piece of selected scenario feature enhancement information, to obtain each enhanced feature sequence, and then all enhanced feature sequences are fused, to obtain an enhanced feature sequence of the user corresponding to an input sequence. That is, feature enhancement is performed by using scenario feature enhancement information of an interaction scenario related to input, so that accuracy of the obtained enhanced feature sequence can be improved, thereby improving accuracy of the embedding representation of the user. In addition, performing feature enhancement on the autocorrelation feature sequence by using all scenario feature enhancement information is avoided, so that calculation complexity can be reduced while ensuring accuracy. Then, the server may save the enhanced feature sequence as a representation of the user, and then perform a subsequent task by using the enhanced feature sequence, for example, perform information push prediction by using the enhanced feature sequence of the user. In an embodiment, after the interaction behavior information of the user and the interaction item identifiers of the user are updated, the stored enhanced feature sequence may be updated by using updated interaction item identifiers of the user, to obtain an updated enhanced feature sequence, thereby ensuring accuracy of the enhanced feature sequence and facilitating subsequent tasks.

The preset candidate item identifiers are preset item identifiers that need to be screened. The preset candidate item identifiers may be item identifiers of all items, or may be item identifiers of some items, for example, may be item identifiers with which the user has not interacted. An interaction degree is configured for representing a possibility that the user interacts with item information of a preset candidate item identifier. A higher interaction degree indicates a higher possibility that the user interacts with corresponding item information.

Specifically, the server may use the enhanced feature sequence of the user to perform item information push, that is, predict preset candidate item identifiers by using the enhanced feature sequence, to obtain interaction degrees respectively corresponding to the preset candidate item identifiers, and then screen the preset candidate item identifiers by using the interaction degrees respectively corresponding to the preset candidate item identifiers. The screening may be performed according to a preset quantity of screening. For example, the server may screen out a preset candidate item identifier having a maximum interaction degree, and push item information of the preset candidate item identifier having the maximum interaction degree to the terminal of the user. Alternatively, the server may screen out preset candidate item identifiers whose interaction degrees are ranked top three, and push item information of the preset candidate item identifiers whose interaction degrees are ranked top three to the terminal of the user. The terminal of the user receives the item information pushed by the server and presents the item information, so that the user can interact with the pushed item information.

According to the foregoing information push method, by obtaining an interaction item identifier sequence, the interaction item identifier sequence including interaction item identifiers of a user; fusing the interaction item feature sequence and the interaction behavior feature sequence to obtain a fused feature sequence, and extracting autocorrelation information of fused features in the fused feature sequence to obtain an autocorrelation feature sequence; and identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, that is, by performing feature enhancement on the autocorrelation feature sequence by using a plurality of pieces of scenario feature enhancement information, item information and interaction behavior information of different interaction scenarios can be better fit, thereby improving accuracy of the obtained enhanced feature sequence, that is, improving accuracy of the obtained user representation. Then, the enhanced feature sequence can be configured for predicting interaction degrees respectively corresponding to preset candidate item identifiers, and performing item information push based on the interaction degrees respectively corresponding to the preset candidate item identifiers, that is, the enhanced feature sequence with high accuracy is configured for performing prediction and perform information push, thereby improving information push accuracy. That is, push of item information with a low interaction degree can be reduced, thereby saving push resources.

In an embodiment, S202 of obtaining an interaction item feature sequence and an interaction behavior feature sequence based on the interaction item identifier sequence includes:

searching pre-extracted interaction item features for interaction item features respectively corresponding to the interaction item identifiers, to obtain the interaction item feature sequence; obtaining, from at least two interaction scenarios to which the interaction item identifiers belong, at least two pieces of interaction behavior information respectively corresponding to the interaction item identifiers; and extracting embedding representations of the at least two pieces of interaction behavior information for each interaction item identifier, to obtain at least two behavior representations, fusing the at least two behavior representations to obtain an interaction behavior feature of each interaction item identifier, and obtaining the interaction behavior feature sequence based on the interaction behavior feature of each interaction item identifier.

The pre-extracted interaction item feature is a feature of item information of an interaction item identifier that is extracted in advance. The behavior representation is obtained by extracting an embedding representation of the interaction behavior information. Different interaction scenarios have different interaction behavior information, and different behavior features may be extracted.

Specifically, the database of the server stores a pre-extracted interaction item feature corresponding to each interaction item identifier. Then, the server may use each interaction item identifier in the interaction item identifier sequence, search pre-extracted interaction item features for interaction item features respectively corresponding to the interaction item identifiers, and sort the interaction item features according to a sequence order of the interaction item identifier sequences, to obtain the interaction item feature sequence. That is, the database is searched for identical interaction item identifiers, and an item feature corresponding to the identical interaction item identifiers is used as an interaction item feature. Then, the server may also obtain, from at least two interaction scenarios to which the interaction item identifiers belong, at least two pieces of interaction behavior information respectively corresponding to the interaction item identifiers. Scenario identifiers of a plurality of interaction scenarios to which each interaction item identifier belongs may be found, and then the database is searched, according to the scenario identifiers, for interaction behavior information that is generated for the interaction item identifier and that is in the interaction scenarios, to obtain interaction behavior information of a plurality of different interaction scenarios of each interaction item identifier.

In this case, for each interaction item identifier, the server extracts, by using an embedding representation extraction algorithm, an embedding representation of each piece of interaction behavior information corresponding to the interaction item identifier, to obtain a behavior representation corresponding to each piece of interaction behavior information. The embedding representation extraction algorithm may be a neural network algorithm, a vectorization algorithm, or the like. Finally, the server integrates all behavior representations of a same interaction item identifier in different interaction scenarios, and may compute a sum of all behavior representations, to obtain an interaction behavior feature of the interaction item identifier. The server traverses and calculates all the interaction item identifiers, to obtain interaction behavior features of all the interaction item identifiers, and sorts the interaction behavior features according to a sequence order of the interaction item identifier sequence, to obtain an interaction behavior feature sequence.

In some embodiments, the server stores pre-extracted item features, and the item features may be obtained by performing feature extraction on item information of all items. Then, if each interaction item identifier of the user is obtained, an item feature of an item identifier the same as the interaction item identifier may be searched for, to obtain an interaction item feature corresponding to each interaction item identifier.

In the foregoing embodiments, by searching pre-extracted interaction item features for interaction item features respectively corresponding to the interaction item identifiers, to obtain the interaction item feature sequence, real-time extraction is not required, thereby improving the efficiency of obtaining the interaction item feature sequence. Then, at least two pieces of interaction behavior information of the interaction item identifiers are obtained; and for each interaction item identifier, embedded representations of the at least two pieces of interaction behavior information are extracted, to obtain at least two behavior representations, and the at least two behavior representations are fused, to obtain an interaction behavior characteristic. By using interaction behavior information of the same item in a plurality of different interaction scenarios to extract an interaction behavior feature of the same item, the interaction behavior feature includes semantic information of the same item in different interaction scenarios, thereby improving accuracy of the interaction behavior feature of the item, and further improving accuracy of the obtained interaction behavior feature sequence.

In an embodiment, the server may obtain the item information of each interaction item identifier in the interaction item identifier sequence, and extract the embedding representation of the item information, to obtain the interaction item feature sequence. In addition, the server obtains the interaction behavior information of each interaction item identifier from the interaction scenario to which each interaction item identifier belongs, and extracts the embedding representation of the interaction behavior information, to obtain the interaction behavior feature sequence. That is, the embedding representation of the item information of each interaction item identifier can be extracted in real time, and the embedding representation of the interaction behavior information can be extracted in real time without pre-extracting item features of all items, so that computing resources of the server can be saved.

In an embodiment, the server may obtain, for each interaction item identifier in the interaction item identifier sequence, each piece of item modality information corresponding to each interaction item identifier, then extract an embedding representation of each piece of item modality information, to obtain each modality embedding feature, and fuse each modality encoding feature, to obtain an interaction item feature sequence. For example, the server may extract an embedding representation of text information in each piece of item modality information corresponding to each interaction item identifier, to obtain a text embedding feature sequence, and extract an embedding representation of picture information in each piece of item modality information corresponding to each interaction item identifier, to obtain a picture embedding feature sequence. Finally, the text embedding feature sequence and the picture embedding feature sequence are fused, to obtain an interaction item feature sequence. That is, embedding representations for information in different modalities are extracted, and finally fused, thereby improving accuracy of an obtained interaction item feature.

In an embodiment, the server may obtain a target fusion feature sequence based on the interaction item identifier sequence. The target fusion feature sequence is obtained by performing feature extraction on target item information of each interaction item identifier, and the target item information is obtained by splicing the item information of each interaction item identifier and the interaction behavior information of each interaction item identifier. For example, the server may splice the text information in the item information and the interaction behavior information, to obtain spliced text information, and then use the spliced text information and item information in another modality together as the target item information. Then, the server performs subsequent enhanced feature sequence extraction by using the target fused feature sequence as a fused feature sequence, to obtain an enhanced feature sequence. That is, the interaction behavior information and the item information are spliced to obtain the target item information, and then feature extraction is performed by using the target item information, so that efficiency of obtaining a fused feature sequence can be improved.

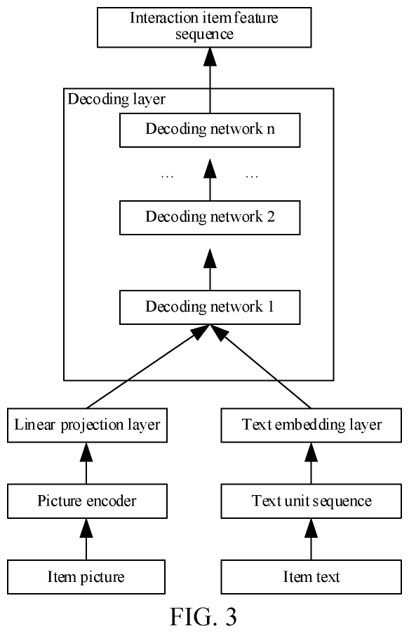

In a specific embodiment, feature extraction may be performed on the item information of each interaction item identifier by using a large language model, to obtain the interaction item feature sequence. FIG. 3 is a schematic diagram of a network architecture of a large language model. Specifically, a server obtains item information of each interaction item identifier. The item information is multi-modal information, including an item picture and item text. The item text may be a name and introduction of an item, type information of the item, or the like. Then, the item picture and the item text are inputted into the large language model, to obtain a token (a basic unit of the large language model, usually being a word, a punctuation mark, or another symbol, and may be further configured for representing context information in the text) sequence of the item text. The item text may be divided by using a basic unit token, to obtain a token sequence of the item text. Then, the token sequence of the text is inputted into a text embedding layer to extract a text embedding representation, to obtain a text embedding feature sequence. Meanwhile, the item picture is encoded by using a picture encoder in the large language model, to obtain an embedding representation of a picture token. Then, linear projection mapping is performed on the embedding representation of the picture token by using a linear projection layer, to map the embedding representation of the picture token to space having a same dimension as that of the embedding representation of the text token, to obtain a picture embedding feature sequence. Then, the server fuses the picture embedding feature sequence and the text embedding feature sequence, and the fused sequence is inputted into a transformer (a neural network model based on a self-attention mechanism, configured for processing sequence data) decoding layer, and is decoded by using a plurality of transformer decoding networks in the transformer decoding layer, that is, the text token is generated by using the transformer decoding layer, to obtain an outputted interaction item feature sequence. The large language model may be LLaVa (a multi-modal pre-training model, which implements cross-modality understanding and generation), MiniGPT (an enhancing vision-language understanding with advanced large language model), BLIP-2 (a multi-modal transformer model), or the like. A picture feature and a text feature may be fused by using the large language model, to perform text generation based on picture information, thereby improving accuracy of an obtained interaction item feature sequence.

In an embodiment, S206, that is, the fusing the interaction item feature sequence and the interaction behavior feature sequence to obtain a fused feature sequence includes an operation:

fusing interaction item features in the interaction item feature sequence and corresponding interaction behavior features in the interaction behavior feature sequence, to obtain the fused feature sequence.

Specifically, the server may calculate a sum of the interaction item feature in the interaction item feature sequence and the corresponding interaction behavior feature in the interaction behavior feature sequence, to obtain the fused feature sequence. The interaction item feature and the corresponding interaction behavior feature are features of a same item, that is, the correspondence is determined according to the item to which the features belong, and the interaction item feature of the item does not correspond to an interaction behavior feature of another item. The server may alternatively obtain the preset importance corresponding to each interaction item identifier, and then fuse the interaction item feature sequence and the interaction behavior feature sequence by using the importance, to obtain the fused feature sequence, that is, calculate a feature sum of an interaction item feature and an interaction behavior feature of a same interaction item identifier, weight the feature sum by using the importance, to obtain a fused feature of the interaction item identifier, and traverse all interaction item identifiers, to obtain a fused feature sequence.

In an embodiment, the server may calculate a linear sum of feature elements in the interaction item feature sequence and the interaction behavior feature sequence according to a same position, to obtain a fused feature sequence.

In an embodiment, the server may input the interaction item feature sequence and the interaction behavior feature sequence into a trained neural network for feature fusion, to perform feature fusion, to obtain an outputted fused feature sequence.

In the foregoing embodiments, by fusing interaction item features in the interaction item feature sequence and corresponding interaction behavior features in the interaction behavior feature sequence, to obtain the fusion feature sequence, the fused feature not only includes the item information, but also includes the interaction behavior information of the interaction scenario, thereby improving accuracy of the obtained fused feature sequence.

In an embodiment, S206, that is, the extracting autocorrelation information of fused features in the fused feature sequence to obtain an autocorrelation feature sequence includes operations:

performing linear transformation on the fused feature sequence, to obtain a target query sequence, a target key sequence, and a target value sequence; and calculating a correlation degree between the target query sequence and the target key sequence, to obtain a correlation degree sequence, and transforming the target value sequence based on the correlation degree sequence, to obtain the autocorrelation feature sequence.

Specifically, the server obtains linear transformation parameters. The linear transformation parameters may include a parameter for obtaining a target query sequence through transformation, a parameter for obtaining a target key sequence through transformation, and a parameter for obtaining a target value sequence through transformation. The linear transformation parameters are preset, or may be obtained through pre-training, for example, may be obtained through training by using a self-attention neural network. Then, linear transformation is performed on the fused feature sequence by using the linear transformation parameters. That is, linear transformation is performed on the fused feature sequence by using the parameter for obtaining the target query sequence through transformation, to obtain the target query sequence, linear transformation is performed on the fused feature sequence by using the parameter for obtaining the target key sequence through transformation, to obtain the target key sequence, and linear transformation is performed on the fused feature sequence by using the parameter for obtaining the target value sequence through transformation, to obtain the target value sequence. In this case, the server calculates a correlation degree between the target query sequence and the target key sequence by using a similarity algorithm, to obtain a correlation degree sequence. The similarity algorithm may be a distance similarity algorithm, a cosine similarity algorithm, a dot product operation, or the like. Finally, the server may normalize the correlation degree sequence, to obtain a normalized correlation degree sequence, and then weight the target value sequence by using the normalized correlation degree sequence, to obtain an autocorrelation feature sequence. That is, autocorrelation information of fused features in the fused feature sequence may be extracted by using a self-attention mechanism, to obtain an autocorrelation feature sequence.

In the foregoing embodiments, by performing linear conversion on the fusion feature sequence, to obtain a target query sequence, a target key sequence, and a target value sequence, and calculating a correlation degree between the target query sequence and the target key sequence, to obtain a correlation degree sequence, a dependency relationship between different positions in the fused feature sequence may be sufficiently extracted, and then the target value sequence is transformed based on the correlation degree sequence, to obtain an autocorrelation feature sequence, thereby improving accuracy of the obtained autocorrelation feature sequence.

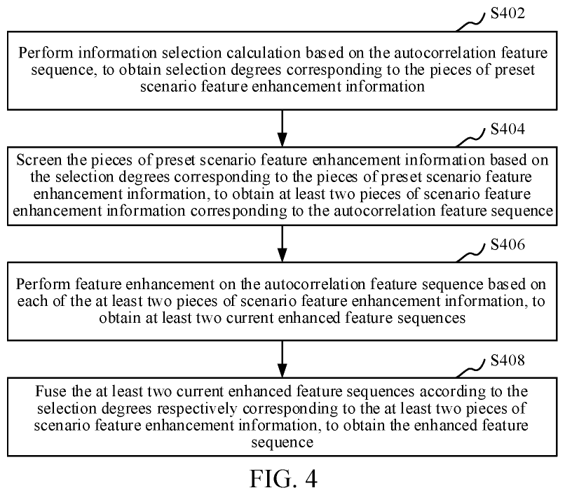

In an embodiment, as shown in FIG. 4, S208 of identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence includes:

S402: Perform information selection calculation based on the autocorrelation feature sequence, to obtain selection degrees corresponding to the pieces of preset scenario feature enhancement information.

The selection degree is configured for representing a correlation degree between the autocorrelation feature sequence and the preset scenario feature enhancement information. A higher correlation degree between the autocorrelation feature sequence and the preset scenario feature enhancement information indicates a higher corresponding selection degree.

Specifically, the server may perform a fully-connected operation on the autocorrelation feature sequence, to obtain a selection degree corresponding to each piece of preset scenario feature enhancement information. When performing the fully-connected operation, the server may perform the operation by using a fully-connected operation parameter that is obtained through pre-training and that is configured for calculating the selection degree, or may perform the operation by using a preset fully-connected operation parameter. In an embodiment, the server may input the autocorrelation feature sequence into a fully-connected neural network for selection degree calculation, to calculate a selection degree corresponding to each piece of preset scenario feature enhancement information. The fully-connected neural network may be pre-trained for performing selection degree calculation.

S404: Screen the pieces of preset scenario feature enhancement information based on the selection degrees corresponding to the pieces of preset scenario feature enhancement information, to obtain at least two pieces of scenario feature enhancement information corresponding to the autocorrelation feature sequence.

S406: Perform feature enhancement on the autocorrelation feature sequence based on each of the at least two pieces of scenario feature enhancement information, to obtain at least two current enhanced feature sequences.

The current enhanced feature sequence is obtained by currently performing feature enhancement on the autocorrelation feature sequence by using the scenario feature enhancement information. Feature enhancement is performed on the autocorrelation feature sequence by using different scenario feature enhancement information to obtain different current enhanced feature sequences.

Specifically, the server screens each piece of preset scenario feature enhancement information according to the selection degree corresponding to each piece of preset scenario feature enhancement information, to obtain a preset quantity of to-be-screened preset scenario feature enhancement information, and the quantity of to-be-screened preset scenario feature enhancement information is at least two. Then, scenario feature enhancement information is selected sequentially in descending order of selection degrees, to obtain at least two pieces of scenario feature enhancement information that are most correlated to and correspond to the autocorrelation feature sequence. In this case, the server performs feature enhancement on the autocorrelation feature sequence by using each piece of scenario feature enhancement information. The feature enhancement may be performing weighting calculation on the autocorrelation feature sequence by using a feature enhancement parameter in the scenario feature enhancement information, that is, calculating a product of the feature enhancement parameter and an autocorrelation feature in the autocorrelation feature sequence. In some embodiments, the feature enhancement may alternatively be calculating a sum of a feature enhancement parameter in the scenario feature enhancement information and the autocorrelation feature sequence. In some embodiments, the feature enhancement may alternatively be performing nonlinear transformation on the autocorrelation feature sequence by using the scenario feature enhancement information. In some embodiments, the feature enhancement may alternatively be weighting the autocorrelation feature sequence through the scenario feature enhancement information by using an attention mechanism, to enhance key information in the autocorrelation feature sequence, thereby obtaining a current enhanced feature sequence corresponding to each piece of scenario feature enhancement information.

In some embodiments, scenario feature enhancement information may be selected from the pieces of preset scenario feature enhancement information by using a dynamic routing mechanism. The dynamic routing mechanism is a technology of adaptively selecting a path inside a neural network, and allows a propagation path of data in the network to dynamically change according to a feature of input data, so that the network is more efficient, that is, only neurons most related to a current task may be activated, thereby reducing unnecessary calculation and parameter use.

S408: Fuse the at least two current enhanced feature sequences according to the selection degrees respectively corresponding to the at least two pieces of scenario feature enhancement information, to obtain the enhanced feature sequence.

Specifically, the server calculates a weighted sum of all current enhanced feature sequences and corresponding selection degrees, to obtain an enhanced feature sequence, that is, calculates a product of each current enhanced feature sequence and a corresponding selection degree, and then calculates a sum of all products, to obtain the enhanced feature sequence.

In the foregoing embodiments, by calculating selection degrees to screen out at least two pieces of scenario feature enhancement information, then performing feature enhancement on the autocorrelation feature sequence, and performing fusion according to the selection degrees, to obtain an enhanced feature sequence, that is, performing feature enhancement by using scenario feature enhancement information most correlated to the autocorrelation feature sequence, and then performing weighted fusion on the enhancement features according to the selection degrees, accuracy of the obtained enhanced feature sequence is improved.

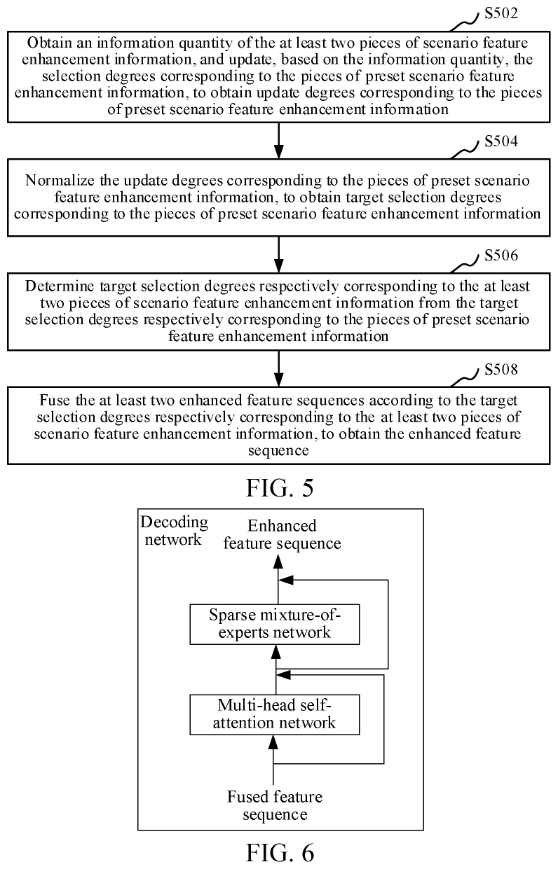

In an embodiment, as shown in FIG. 5, S408 of fusing the at least two current enhanced feature sequences according to the selection degrees respectively corresponding to the at least two pieces of scenario feature enhancement information, to obtain the enhanced feature sequence includes:

S502: Obtain an information quantity of the at least two pieces of scenario feature enhancement information, and update, based on the information quantity, the selection degrees corresponding to the pieces of preset scenario feature enhancement information, to obtain update degrees corresponding to the pieces of preset scenario feature enhancement information.

The information quantity is the quantity of selected scenario feature enhancement information, and the information quantity may be a preset quantity of to-be-selected scenario feature enhancement information. The update degree is an updated selection degree, and is configured for representing a possibility of selecting the corresponding scenario feature enhancement information when feature enhancement is performed.

Specifically, the server obtains a preset information quantity of pieces of scenario feature enhancement information to be screened out. The server may also count the information quantity of pieces of scenario feature enhancement information that have been screened out. Then, the selection degree corresponding to each piece of preset scenario feature enhancement information is updated based on the information quantity. The server may classify, based on the information quantity, the selection degree corresponding to each piece of preset scenario feature enhancement information into different types of selection degrees, and then update the different types of selection degrees according to preset different types of update rules. The different types of selection degrees may include a selection degree needing to be updated and a selection degree needing to be maintained unchanged. Selection degrees corresponding to the at least two pieces of scenario feature enhancement information screened out may be used as selection degrees that remain unchanged, a selection degree corresponding to the remaining scenario feature enhancement information is used as a selection degree that needs to be updated, and then the selection degree that needs to be updated is updated. For example, weighting may be performed according to a preset update weight, or the selection degree that needs to be updated is updated to a preset target value, and the selection degree that remains unchanged is kept unchanged, to obtain an update degree corresponding to each piece of preset scenario feature enhancement information.

S504: Normalize the update degrees corresponding to the pieces of preset scenario feature enhancement information, to obtain target selection degrees corresponding to the pieces of preset scenario feature enhancement information.

The target selection degree is a selection degree obtained by normalizing an update degree of each piece of preset scenario feature enhancement information. A sum of the target selection degrees of all the preset scenario feature enhancement information is a target value. The target value may be 1, or may be another value.

Specifically, the server may normalize, by using a normalization algorithm, the update degree corresponding to each piece of preset scenario feature enhancement information. The normalization algorithm may be a minimum-maximum normalization algorithm, a scaling normalization algorithm, a mean variance normalization algorithm, or the like, to obtain the target selection degree of each piece of preset scenario feature enhancement information.

S506: Determine target selection degrees respectively corresponding to the at least two pieces of scenario feature enhancement information from the target selection degrees respectively corresponding to the pieces of preset scenario feature enhancement information.

S508: Fuse the at least two current enhanced feature sequences according to the target selection degrees respectively corresponding to the at least two pieces of scenario feature enhancement information, to obtain the enhanced feature sequence.

Specifically, the server determines target selection degrees respectively corresponding to the at least two pieces of scenario feature enhancement information that are screened out from the target selection degrees respectively corresponding to the pieces of preset scenario feature enhancement information, and then calculates a weighted sum of the at least two enhanced feature sequences according to the target selection degrees respectively corresponding to the at least two pieces of scenario feature enhancement information, to obtain the enhanced feature sequence.

In an embodiment, alternatively, the server may obtain selection degrees respectively corresponding to the at least two pieces of scenario feature enhancement information that are screened out, and then directly normalize the selection degrees respectively corresponding to the at least two pieces of scenario feature enhancement information, to obtain the target selection degrees respectively corresponding to the at least two pieces of scenario feature enhancement information.

In the foregoing embodiments, selection degrees of all the scenario feature enhancement information are updated and normalized, to further determine a target selection degree of the scenario feature enhancement information screened out. That is, through uniform update and normalization, accuracy of the obtained target selection degree is improved. Then, the at least two current enhanced feature sequences are fused by using the target selection degree, to obtain an enhanced feature sequence, thereby improving accuracy of the obtained enhanced feature sequence.

In an embodiment, S502 of updating, based on the information quantity, the selection degrees corresponding to the pieces of preset scenario feature enhancement information, to obtain update degrees corresponding to the pieces of preset scenario feature enhancement information includes operations:

determining, based on the information quantity, first selection degrees and second selection degrees from the selection degrees corresponding to the pieces of preset scenario feature enhancement information, the first selection degrees being all greater than the second selection degrees, and a quantity of the first selection degrees being the same as the information quantity; and keeping the first selection degrees unchanged, and updating the second selection degrees to a preset target value, to obtain update degrees corresponding to the pieces of preset scenario feature enhancement information.

The first selection degrees refer to selection degrees that are obtained by screening all selection degrees in descending order and whose quantity that is the same as the information quantity. The second selection degrees refer to selection degrees other than the first selection degrees, that is, selection degrees remaining after the information quantity of selection degrees are screened in descending order. The preset target value is a target value that is set in advance, and is configured for filtering preset scenario feature enhancement information with a relatively low selection degree, to ensure that when feature fusion is performed, the preset scenario feature enhancement information screened out is used. The preset target value may be negative infinity.

Specifically, the server sequentially screens, according to the information quantity, the selection degrees corresponding to the pieces of preset scenario feature enhancement information in descending order, to obtain first selection degrees, that is, a quantity of the first selection degrees is the same as the information quantity, and then uses other selection degrees as second selection degrees. Then, the server keeps the first selection degrees unchanged, and updates all the second selection degrees to a preset target value. In this case, an update degree of each piece of preset scenario feature enhancement information is obtained.

In a specific embodiment, a selection degree corresponding to each piece of preset scenario feature enhancement information may be updated by using formula (1) shown below.

$${TopK ( L )}_{i} = \{ \begin{matrix}{L}_{i} ( if {L}_{i} is among top k ) \\ - ∞ ( if {L}_{i} is not among top k )\end{matrix} \qquad formula ( 1 )$$

where top k refers to being ranked top k. k may be the information quantity, and k may be preset to 2. Lᵢ refers to a selection degree of an ith preset scenario feature enhancement information. −∞ refers to negative infinity. TopK(L)ᵢ refers to an ith updated selection degree. Then, the update degree may be normalized by using formula (2) shown below.

$$G ( x ) = Softmax ( TopK ( {xW}_{g} ) ) \qquad formula ( 2 )$$

where x refers to the autocorrelation feature sequence. W_{g} refers to an information selection calculation parameter, and may be, for example, a fully-connected operation parameter. A selection degree of each piece of preset scenario feature enhancement information is obtained by calculating a product of the autocorrelation feature sequence and the information selection calculation parameter, and then TopK(xW_{g}) is calculated by using formula (1), where TopK(xW_{g}) refers to an update degree of pieces of preset scenario feature enhancement information that are ranked top k. Softmax refers to a normalization function. G (x) refers to a target selection degree obtained after normalizing the update degree of the pieces of preset scenario feature enhancement information that are ranked top k.

In the foregoing embodiments, the first selection degrees are kept unchanged, and the second selection degrees are updated to a preset target value, to obtain update degrees corresponding to the pieces of preset scenario feature enhancement information; and then, during normalization, the preset scenario feature enhancement information that is not selected may be screened, to avoid using the preset scenario feature enhancement information that is not selected to perform feature enhancement, thereby improving accuracy of feature enhancement.

In an embodiment, S508, that is, the fusing the at least two current enhanced feature sequences according to the target selection degrees respectively corresponding to the at least two pieces of scenario feature enhancement information, to obtain the enhanced feature sequence includes:

weighting, for each piece of scenario feature enhancement information, a corresponding current enhanced feature sequence according to a target selection degree, to obtain each weighted feature sequence; and fusing the weighted feature sequences, to obtain the enhanced feature sequence.

Specifically, the server calculates a product of the target selection degree of the scenario feature enhancement information screened out and the current enhanced feature sequence of the scenario feature enhancement information, to obtain a weighted feature sequence corresponding to the scenario feature enhancement information, and traverses all the scenario feature enhancement information screened out, to obtain each weighted feature sequence. Finally, the server calculates a sum of all the weighted feature sequences, which may be a linear sum of feature elements at a same position in all the weighted feature sequences, or may calculate a product of all the weighted feature sequences, which may be a multiplication of feature elements at a same position in all the weighted feature sequences, to obtain an enhanced feature sequence.

In a specific embodiment, the enhanced feature sequence may be calculated by using formula (3) shown below.

$${\sum }_{i = 0}^{n - 1} {G ( x )}_{i} \cdot {E}_{i} ( x ) \qquad formula ( 3 )$$

where G(x)ᵢ is a target selection degree of an ith piece of scenario feature enhancement information, Eᵢ(x) is an ith current enhanced feature sequence, and n is an information quantity of the at least two pieces of scenario feature enhancement information.

In the foregoing embodiments, by weighting a corresponding current enhanced feature sequence according to a target selection degree, to obtain each weighted feature sequence, and then fusing the weighted feature sequences, to obtain the enhanced feature sequence, that is, by weighting the target selection degree, and then performing fusion, accuracy of the obtained enhanced feature sequence is improved.

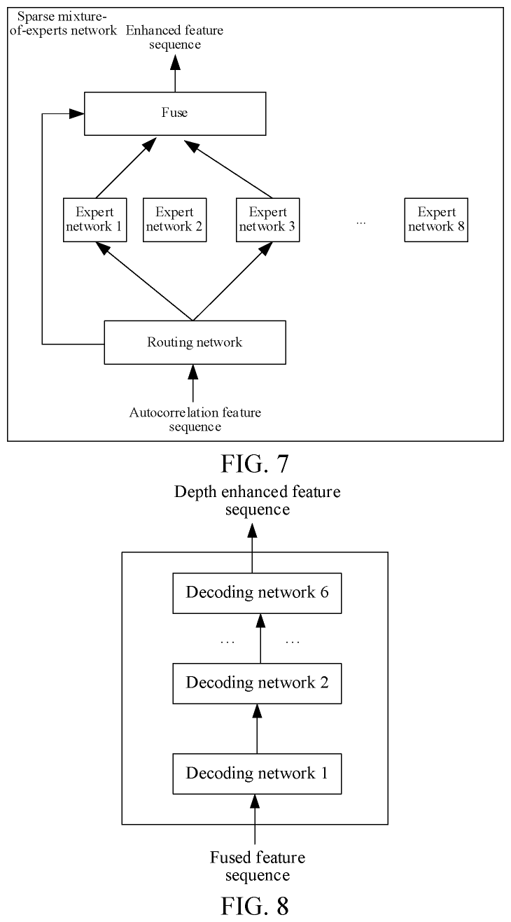

In a specific embodiment, as shown in FIG. 6, a schematic diagram of a network architecture for obtaining an enhanced feature sequence is provided. Specifically, a server inputs a fused feature sequence into a transformer decoding network, and the transformer decoding network is obtained by replacing a feedforward neural network after a multi-head self-attention network with a sparse mixture-of-experts network. That is, the transformer decoding network includes the multi-head self-attention network with a masking mechanism and the sparse mixture-of-experts network, and the transformer decoding network further includes a residual connection and layer normalization network that is not shown in the figure. The server performs multi-head self-attention calculation on the fused feature sequence by using the multi-head self-attention network with the masking mechanism, to capture a dependency relationship between different positions in an input sequence, thereby obtaining an autocorrelation feature sequence. Then, a residual connection is performed by using the residual connection and layer normalization network, and a result of the residual connection is normalized, so as to improve network performance. Feature enhancement is performed on the autocorrelation feature sequence by using the sparse mixture-of-experts network, to obtain an enhanced feature sequence. A schematic diagram of a network architecture of the sparse hybrid expert network may be shown in FIG. 7. The sparse mixture-of-experts network includes a routing network and expert networks. The expert networks are configured for representing corresponding preset scenario feature enhancement information. A network architecture of the expert network is the same as a network architecture of the feedforward neural network in the transformer decoding network. Each expert network may focus on processing a subtask that the expert network is good at, so that different expert networks can process autoregressive problems in an interaction scenario that the expert networks are good at. Then, the server inputs the autocorrelation feature sequence into the sparse mixture-of-experts network, and first determines, by using the routing network, an expert network into which the autocorrelation feature sequence needs to be inputted. For example, the sparse mixture-of-experts network may include a total of eight expert networks, only top k expert networks of which need to be activated, where k may be 2. That is, the server inputs the autocorrelation feature sequence into the routing network, and calculates selection probabilities of the eight expert networks by using the routing network. The routing network may use L=xW_{g} to calculate a selection probability, W_{g} is a network parameter of the routing network, and the routing network may be a fully-connected neural network. Then, two maximum selection probabilities and corresponding expert networks are determined according to the selection probabilities of the eight expert networks. Then, the selection probabilities of the eight expert networks are updated by using formula (1), that is, the two maximum selection probabilities are kept unchanged, and the other 6 selection probabilities are set to negative infinity. Then, formula (2) is configured for normalizing the updated selection probabilities, so as to determine update probabilities that the inputted autocorrelation feature sequence enters the top k expert networks, and ensure that a probability that the inputted autocorrelation feature sequence enters expert networks that are not top k is 0. Then, the autocorrelation feature sequence is inputted into the two expert networks with the maximum selection probabilities for feature enhancement, to obtain current enhanced feature sequences outputted by the two expert networks. Then, an enhanced feature sequence is calculated through formula (3) by using the update probabilities of the two expert networks and the current enhanced feature sequences outputted by the two expert networks, that is, only the two expert networks may be activated to perform feature enhancement, thereby reducing calculation complexity and improving calculation efficiency.

In an embodiment, after S208, that is, after the performing feature enhancement on the autocorrelation feature sequence based on the at least two pieces of scenario feature enhancement information to obtain an enhanced feature sequence, the method further includes an operation:

using the enhanced feature sequence as the fused feature sequence, and returning to iteratively perform the operation of extracting autocorrelation information of fused features in the fused feature sequence to obtain an autocorrelation feature sequence, until a depth enhancement completion condition is satisfied, to obtain a depth enhanced feature sequence, the depth enhanced feature sequence being configured for predicting depth interaction degrees respectively corresponding to preset candidate item identifiers, and performing item information push based on the depth interaction degrees respectively corresponding to the preset candidate item identifiers.

The depth enhancement completion condition is a condition under which looping and iterative execution ends, may be a condition under which a depth enhanced feature sequence is extracted, and includes but is not limited to that a quantity of times of iterative execution reaches a set maximum quantity of times. The depth enhanced feature sequence refers to an enhanced feature sequence obtained after a plurality of times of iterative execution, and patterns and associations at a deep level can be extracted, so that the obtained depth enhanced feature sequence includes semantic information at a deep level. The depth interaction degree refers to an interaction degree that is of the user for the item information of the preset candidate item identifier and that is obtained after a plurality of times of iterative execution.

Specifically, the server may perform a plurality of times of iterative execution, to extract depth information from the fused feature sequence, to obtain a depth enhanced feature sequence. Parameters used during autocorrelation feature extraction and feature enhancement in each iteration may be the same or may be different. That is, the server may use the enhanced feature sequence as the fused feature sequence, and return to perform the operation of extracting autocorrelation information of fused features in the fused feature sequence to obtain an autocorrelation feature sequence; and each time an enhanced feature sequence is obtained, determine whether the depth enhancement completion condition is satisfied. When the depth enhancement completion condition is not satisfied, the obtained enhanced feature sequence is used as a start input of a next iteration. When the depth enhancement completion condition is satisfied, the obtained enhanced feature sequence is used as a finally extracted depth enhanced feature sequence, and the depth enhanced feature sequence is used as a representation of the user. Then, the server may perform subsequent task processing by using the depth enhanced feature sequence, for example, may perform item information push, or may perform item information recalling or sorting.

In an embodiment, as shown in FIG. 8, a diagram of a network architecture for obtaining a depth enhanced feature sequence is provided. The network architecture includes n transformer decoding networks. The network architecture of the n transformer decoding networks may be the network architecture shown in FIG. 6. Network parameters of the n transformer decoding networks are different, and are trained in advance, and n may be preset according to experience, for example, may be set to 6. Then, a server inputs a fused feature sequence into a first transformer decoding network to extract an outputted enhanced feature sequence, uses the enhanced feature sequence as an input of a second transformer decoding network, extracts the outputted enhanced feature sequence by using the second transformer decoding network, and inputs the enhanced feature sequence into a next transformer decoding network. Then, until the outputted enhanced feature sequence is extracted by using a last transformer decoding network, a depth enhanced feature sequence is obtained. Enhancement feature extraction is performed by using a plurality of transformer decoding networks, thereby improving accuracy of the obtained enhanced feature sequence.

In the foregoing embodiments, the depth enhanced feature sequence is obtained by performing iteration, so that related information in the input sequence can be extracted in depth, thereby improving accuracy of the depth enhanced feature sequence. Then, the depth enhanced feature sequence is configured for performing information push, thereby improving information push accuracy.

In an embodiment, after S208, that is, after the identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, the method further includes operations:

performing linear transformation on the enhanced feature sequence based on the preset candidate item identifiers, to obtain linear transformation features respectively corresponding to the preset candidate item identifiers; performing interaction degree mapping on the linear transformation features respectively corresponding to the preset candidate item identifiers, to obtain the interaction degrees respectively corresponding to the preset candidate item identifiers; screening the preset candidate item identifiers based on the interaction degrees respectively corresponding to the preset candidate item identifiers, to obtain a target item identifier; and pushing item information of the target item identifier.

The linear transformation feature is a feature obtained after linear transformation is performed on the enhanced feature sequence. The target item identifier is a candidate item identifier corresponding to a maximum interaction degree that is finally screened out.

Specifically, the server obtains a linear transformation parameter corresponding to each preset candidate item identifier, and performs linear transformation on the enhanced feature sequence by using the linear transformation parameter, to obtain a linear transformation feature sequence. In some embodiments, alternatively, all preset candidate item identifiers may correspond to a common linear transformation parameter, and then linear transformation may be performed on the enhanced feature sequence by using the common linear transformation parameter. Then, the linear transformation feature sequence is normalized and mapped by using a normalization function, to obtain an interaction degree corresponding to each preset candidate item identifier. The interaction degree may be represented by using a probability. Then, the preset candidate item identifiers are screened according to the interaction degrees, to obtain a target item identifier corresponding to a maximum interaction degree. Finally, the server pushes item information of the target item identifier to the terminal of the user.

In an embodiment, the server may predict an interaction degree by using a preset neural network output layer. That is, the enhanced feature sequence is inputted into the neural network output layer, and output calculation is performed on the enhanced feature sequence by using a linear transformation network of the neural network output layer and a normalization function, to obtain the interaction degree corresponding to each outputted preset candidate item identifier. Then, the candidate item identifier corresponding to the maximum interaction degree is selected as the target item identifier, or a plurality of candidate item identifiers ranked top may be selected as to-be-pushed item identifiers, and finally, item information of the to-be-pushed item identifier is pushed to the terminal of the user. That is, through linear transformation, an output of the last transformer decoding network is mapped to a vector space whose dimension is equal to a quantity of all candidate item identifiers. A softmax function transforms each element in the vector space into a probability value, indicating a probability of a next candidate item identifier to be pushed. Then, the target item identifier is screened out from all the candidate item identifiers according to the probabilities of all the candidate item identifiers, and the item information of the target item identifier is obtained and pushed to the terminal of the user.

In the foregoing embodiments, the interaction degree corresponding to each preset candidate item identifier is calculated by using the enhanced feature sequence. Then, the candidate item identifier having the maximum interaction degree is screened out to obtain the target item identifier, that is, item information of the target item identifier having the maximum interaction degree is pushed to the terminal of the user, so as to avoid pushing information in which the user is not interested, thereby improving information push accuracy.

In an embodiment, the information push method further includes operations:

inputting the interaction item identifier sequence into an information push model, the information push model including a feature extraction network, an autocorrelation feature extraction network, a feature enhancement network, and an information push network; obtaining, by using the feature extraction network, an interaction item feature sequence and an interaction behavior feature sequence that correspond to the interaction item identifier sequence, and fusing the interaction item feature sequence and the interaction behavior feature sequence, to obtain a fused feature sequence; extracting, by using the autocorrelation feature extraction network, autocorrelation information of fused features in the fused feature sequence to obtain an autocorrelation feature sequence; identifying, by using the feature enhancement network from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence; and predicting, by using the information push network, interaction degrees respectively corresponding to preset candidate item identifiers based on the enhanced feature sequence, and performing item information push based on the interaction degrees respectively corresponding to the preset candidate item identifiers.

The information push model is a neural network model for information push. The information push model may be obtained by performing training by using a historical interaction item identifier sequence. The historical interaction item identifier sequence includes historical interaction item identifiers of the user. The feature extraction network is a neural network for feature extraction, and may be a neural network for embedding representation extraction, a vectorized neural network, or the like. The autocorrelation feature extraction network is a neural network for autocorrelation feature extraction, and may be a self-attention network. The feature enhancement network is a neural network for feature enhancement, and may be a sparse mixture-of-experts network. The information push network is a neural network for information push, and may be an output layer of a neural network.

Specifically, the interaction item identifier sequence is inputted into an information push model, and the information push model may implement the operations of the information push method in any of the foregoing embodiments. The information push model includes a feature extraction network, an autocorrelation feature extraction network, a feature enhancement network, and an information push network. The feature extraction network may implement operations of the method for obtaining a fused feature sequence in any of the foregoing embodiments. The autocorrelation feature extraction network may implement operations of the method for obtaining an autocorrelation feature sequence in any of the foregoing embodiments. The feature enhancement network may implement operations of the method for obtaining an enhanced feature sequence in any of the foregoing embodiments. The information push network may implement operations of the method for obtaining an interaction degree corresponding to each preset candidate item identifier in any of the foregoing embodiments. That is, by using the information push model, the server may obtain interaction degrees respectively corresponding to preset candidate item identifiers, and then perform item information push based on the interaction degrees respectively corresponding to the preset candidate item identifiers.

In an embodiment, the server obtains interaction item identifiers, obtains a padding mask when a sequence length formed by the interaction item identifiers is less than a preset sequence length, and obtains an interaction item identifier sequence of the preset sequence length by using the interaction item identifiers and the padding mask. In the foregoing embodiments, by inputting the interaction item identifier sequence into the information push model, to obtain an interaction degree corresponding to each preset candidate item identifier, and performing item information push based on the interaction degrees respectively corresponding to the preset candidate item identifiers, that is, performing information push by using the pre-trained information push model, information push efficiency can be improved.

In an embodiment, training of the information push model includes the following operations:

obtaining a historical interaction item identifier sequence, and determining a training interaction item identifier sequence and an item identifier training label based on the historical interaction item identifier sequence; inputting the training interaction item identifier sequence into an initial information push model, to obtain training interaction degrees respectively corresponding to outputted training candidate item identifiers; performing loss calculation based on the training interaction degrees respectively corresponding to the training candidate item identifiers and the item identifier training label, to obtain loss information; and training the initial information push model based on the loss information, and obtaining the information push model when a training completion condition is satisfied.

The historical interaction item identifier sequence includes historical interaction item identifiers of the user, and the historical interaction item identifier is an item identifier on which the user historically performs an interaction behavior. The training interaction item identifier sequence is a historical interaction item identifier sequence used during training. The item identifier training label is a label of an item identifier used during training, and includes an item pushing label and an item non-pushing label. The initial information push model is an information push model for model parameter initialization. The initial information push model may be established by using a neural network. The neural network may be a convolutional neural network, a recurrent neural network, a feedforward neural network, or the like. The loss information is configured for representing an error between a training interaction degree and an item identifier training label. The training completion condition is a condition under which training ends, and includes, but is not limited to, that the quantity of iterations reaches a maximum quantity of iterations, that the model parameter no longer changes, or that the loss information of the model is less than a preset loss threshold. The training candidate item identifier is configured for uniquely identifying a candidate item identifier used in a training process, and may be the same as or different from a preset candidate item identifier used in an application process.

Specifically, the server may obtain a historical interaction item identifier sequence from a database, then select a training interaction item identifier sequence from the historical interaction item identifier sequence, and determine a next historical interaction item identifier of the training interaction item identifier sequence from the historical interaction item identifier sequence as an item identifier training label. For example, there are m historical interaction item identifiers in the historical interaction item identifier sequence. The server may use top q−1 (q is less than m) historical interaction item identifiers in the historical interaction item identifier sequence as a training interaction item identifier sequence, and then determine an item identifier training label according to a q^{th} historical interaction item identifier. That is, the q^{th} historical interaction item identifier is set to a next item pushing label, and other historical interaction item identifiers are set to item non-pushing labels. Then, the server inputs the training interaction item identifier sequence into the initial information push model, and performs prediction by using an initialization model parameter in the initial information push model, to obtain a training interaction degree corresponding to each outputted preset candidate item identifier. Then, a preset loss function is configured for calculating an error between the training interaction degree corresponding to each preset candidate item identifier and the item identifier training label, to obtain the loss information. The loss function may be a cross-entropy loss function, or may be a logarithmic loss function. Then, the initial information push model is inversely updated by using a gradient descent algorithm, to obtain an updated information push model. In this case, the server determines whether the training completion condition is satisfied. When the training completion condition is not satisfied, the server uses the updated information push model as the initial information push model, returns to iteratively perform the operation of the initial information push model, and when the training completion condition is satisfied, uses an updated information push model obtained last time as a finally trained information push model. In this case, the server may deploy and use the trained information push model.

In a specific embodiment, the target function trained by the server may be a negative log-likelihood loss. Specifically, a target of the logarithmic loss function is to predict a probability that a user of a next item interacts with the item under a maximization condition. The logarithmic loss function may be shown in the following formula (4):

$$LOSS = - {\sum }_{t = 1}^{n} log P ( {x}_{t} \vert {x}_{< t} ) \qquad formula ( 4 )$$

where LOSS refers to a negative log-likelihood loss. x_{<t} is a sequence of historical interaction item identifiers at the first position to a (t−1)^{th} position. xₜ in an item sequence X=(x₁ . . . xₙ) with a length of n is a historical interaction item identifier at a t^{th} position. P(xₜ|x_{<t}) represents an interaction probability that xₜ is predicted after the historical interaction item identifier sequence of x_{<t} is given. In a training process, a negative logarithmic loss function is minimized by using an optimization algorithm such as stochastic gradient descent, and parameters of the initial information push model are updated, so that the information push model can better predict an item identifier that the user will interact with next.

In the foregoing embodiments, the initial information push model is trained by using the training interaction item identifier sequence and the item identifier training label, and the information push model is obtained when the training completion condition is satisfied, thereby improving accuracy of performing information push by the information push model.

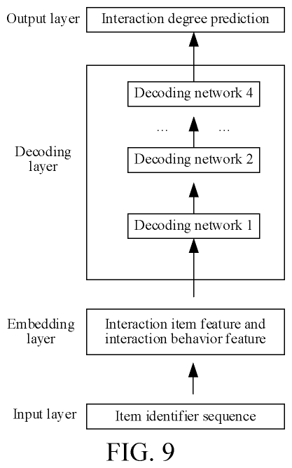

In a specific embodiment, as shown in FIG. 9, a schematic diagram of a model architecture of an information push model is provided. The information push model includes an input layer, an embedding layer, a transformer decoding layer, and an output layer. Specifically, a server inputs an interaction item identifier sequence to the information push model through the input layer, then the information push model extracts an interaction item feature and an interaction behavior feature corresponding to the interaction item identifier sequence through the embedding layer, and after fusing the interaction item feature and the interaction behavior feature, inputs a fused feature sequence to the transformer decoding layer, the transformer decoding layer extracts a depth enhanced feature sequence corresponding to the fused feature sequence through the network architecture shown in FIG. 8, and then inputs the depth enhanced feature sequence to the output layer, to predict a probability distribution through the output layer, where the probability distribution indicates an interaction degree corresponding to each candidate item identifier. Then, an item identifier having a maximum interaction degree is selected as an item identifier to which item information needs to be pushed to a user next, and the item information is pushed to a terminal of the user. That is, modalities to which different item identifiers belong and scenario behavior information are better distinguished by using a sparse mixture-of-experts network, so as to better fit multi-modal and multi-scenario sequence behavior features of the user, thereby implementing a more accurate information push service.

In an embodiment, the interaction item identifier sequence includes an interaction video identifier sequence, the interaction video identifier sequence includes interaction video identifiers of the user, the preset candidate item identifiers include preset candidate video identifiers, and the information push method further includes operations:

obtaining an enhanced feature sequence corresponding to the interaction video identifier sequence, and predicting, based on the enhanced feature sequence corresponding to the interaction video identifier sequence, interaction degrees respectively corresponding to the preset candidate video identifiers; screening the preset candidate video identifiers based on the interaction degrees respectively corresponding to the preset candidate video identifiers, to obtain a target video identifier; and pushing video information of the target video identifier.

The interaction video identifier is configured for uniquely identifying an interaction video, and the interaction video is a video on which the user performs an interaction behavior. The preset candidate video identifier is a candidate video identifier that is set in advance. The target video identifier is a candidate video identifier having a maximum interaction degree.

Specifically, the server performs a video information push service. When performing video information push, the server obtains an interaction video identifier sequence of the user, then inputs the interaction video identifier sequence into the information push model, to obtain an interaction degree corresponding to each outputted preset candidate video identifier, and then selects a candidate video identifier having a maximum interaction degree, to obtain a target video identifier. Finally, the server pushes video information of the target video identifier to the terminal of the user. The terminal of the user receives the video information pushed by the server, and may present the video information, for example, play video content, present a video name, present video introduction, and present a video type.

In the foregoing embodiments, an interaction video identifier sequence is obtained, a target video identifier is predicted based on the interaction video identifier sequence, and video information of the target video identifier is pushed, to improve accuracy of pushing the video information, and further improve a possibility that a user interacts with the pushed video, thereby improving a conversion rate of the pushed video and saving pushing resources.

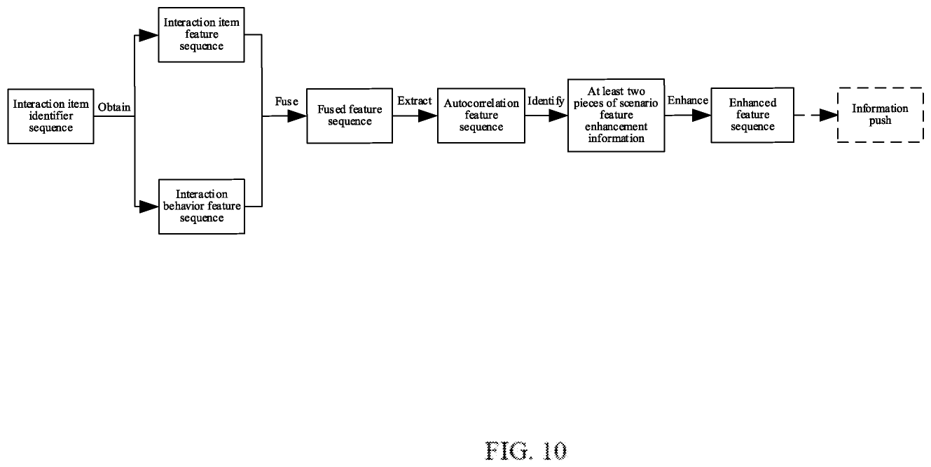

In a specific embodiment, as shown in FIG. 10, a schematic principle diagram of an information push method is provided. Specifically, a server obtains an interaction item identifier sequence of a user, searches for corresponding interaction item features and interaction behavior features according to interaction item identifiers in the interaction item identifier sequence, to obtain an interaction item feature sequence and an interaction behavior feature sequence, and then fuses the interaction item feature sequence with the interaction behavior feature sequence, to obtain a fused feature sequence. The server further extracts an autocorrelation feature sequence of the fused feature sequence, identifies, from pieces of preset scenario feature enhancement information, at least two pieces of feature enhancement information corresponding to the autocorrelation feature sequence, and then performs feature enhancement on the autocorrelation feature sequence by using all identified feature enhancement information, to obtain an enhanced feature sequence. In this case, the enhanced feature sequence is used as a representation of the user. Then, information push may be performed by using the enhanced feature sequence. That is, feature enhancement is performed on the autocorrelation feature sequence by using a plurality of pieces of different feature enhancement information, thereby improving accuracy of an obtained enhanced feature sequence. Then, information push is performed by using the enhanced feature sequence, thereby improving information push accuracy.

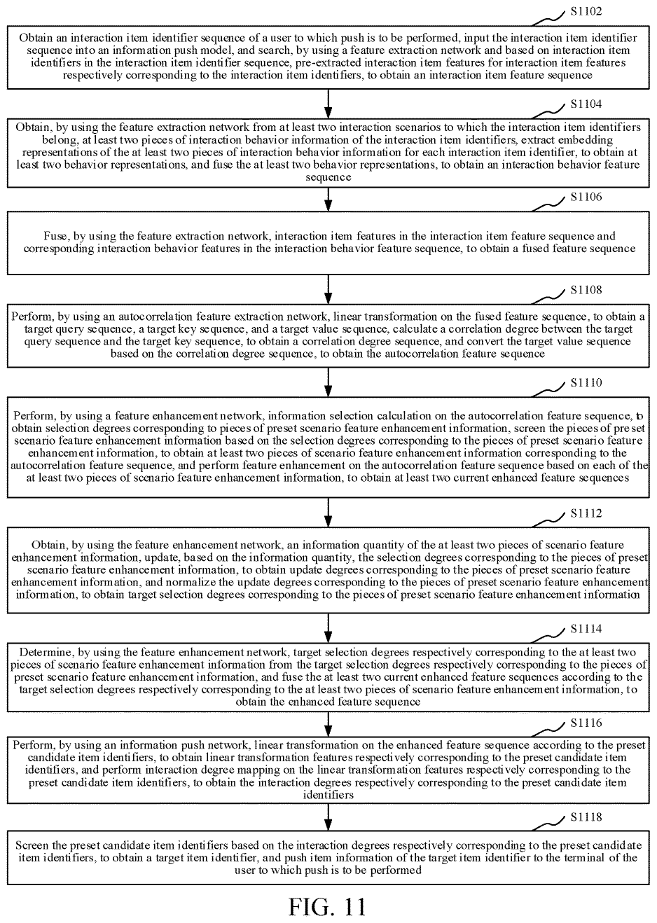

In a specific embodiment, as shown in FIG. 11, a schematic flowchart of an information push method is provided. The method is performed by a computer device. The computer device may be a server, or may be a terminal. In this embodiment, a description is made by using an example in which the computer device is a server. The following operations are specifically included.

S1102: Obtain an interaction item identifier sequence of a user to which pushing is to be performed, input the interaction item identifier sequence into an information push model, and search, by using a feature extraction network and based on interaction item identifiers in the interaction item identifier sequence, pre-extracted interaction item features for interaction item features respectively corresponding to the interaction item identifiers, to obtain an interaction item feature sequence.

S1104: Obtain, by using the feature extraction network from at least two interaction scenarios to which the interaction item identifiers belong, at least two pieces of interaction behavior information of the interaction item identifiers, extract embedding representations of the at least two pieces of interaction behavior information for each interaction item identifier, to obtain at least two behavior representations, and fuse the at least two behavior representations, to obtain an interaction behavior feature sequence.

S1106: Fuse, by using the feature extraction network, interaction item features in the interaction item feature sequence and corresponding interaction behavior features in the interaction behavior feature sequence, to obtain a fused feature sequence.

S1108: Perform, by using an autocorrelation feature extraction network, linear transformation on the fused feature sequence, to obtain a target query sequence, a target key sequence, and a target value sequence, calculate a correlation degree between the target query sequence and the target key sequence, to obtain a correlation degree sequence, and transform the target value sequence based on the correlation degree sequence, to obtain the autocorrelation feature sequence.

S1110: Perform, by using a feature enhancement network, information selection calculation on the autocorrelation feature sequence, to obtain selection degrees corresponding to pieces of preset scenario feature enhancement information, screen the pieces of preset scenario feature enhancement information based on the selection degrees corresponding to the pieces of preset scenario feature enhancement information, to obtain at least two pieces of scenario feature enhancement information corresponding to the autocorrelation feature sequence, and perform feature enhancement on the autocorrelation feature sequence based on each of the at least two pieces of scenario feature enhancement information, to obtain at least two current enhanced feature sequences.

S1112: Obtain, by using the feature enhancement network, an information quantity of the at least two pieces of scenario feature enhancement information, update, based on the information quantity, the selection degrees corresponding to the pieces of preset scenario feature enhancement information, to obtain update degrees corresponding to the pieces of preset scenario feature enhancement information, and normalize the update degrees corresponding to the pieces of preset scenario feature enhancement information, to obtain target selection degrees corresponding to the pieces of preset scenario feature enhancement information.

S1114: Determine, by using the feature enhancement network, target selection degrees respectively corresponding to the at least two pieces of scenario feature enhancement information from the target selection degrees respectively corresponding to the pieces of preset scenario feature enhancement information, and fuse the at least two current enhanced feature sequences according to the target selection degrees respectively corresponding to the at least two pieces of scenario feature enhancement information, to obtain the enhanced feature sequence.

S1116: Perform, by using an information push network, linear transformation on the enhanced feature sequence according to the preset candidate item identifiers, to obtain linear transformation features respectively corresponding to the preset candidate item identifiers, and perform interaction degree mapping on the linear transformation features respectively corresponding to the preset candidate item identifiers, to obtain the interaction degrees respectively corresponding to the preset candidate item identifiers.

S1118: Screen the preset candidate item identifiers based on the interaction degrees respectively corresponding to the preset candidate item identifiers, to obtain a target item identifier, and push item information of the target item identifier to the terminal of the user to which pushing is to be performed.

In the foregoing embodiments, the item information of the target item identifier is pushed, by using the information push model, to the terminal of the user to which pushing is to be performed, so as to improve accuracy of the pushed item information based on improving efficiency of item information push, improve a possibility of interaction between the user and the pushed item information, further improve a conversion rate of the pushed item information, reduce pushing of item information with a low interaction possibility, and further save pushing resources.

In a specific embodiment, the information push method may be applied to a commodity information push platform. Specifically, a server of the commodity information push platform obtains a commodity pushing request sent by a terminal of a user, finds a historical interaction commodity sequence of the user from a database according to the commodity pushing request, inputs the historical interaction commodity sequence into a deployed information push model, predicts, by using the information push model, an interaction degree corresponding to each candidate commodity identifier, and then selects a commodity identifier with a maximum interaction degree, to obtain a target commodity identifier. Finally, the server of the commodity information push platform pushes commodity information of the target commodity identifier to the terminal of the user, and the terminal of the user receives the commodity information and presents the commodity information in the commodity information push platform. The user may interact with the presented commodity information by using the commodity information push platform, so as to avoid pushing commodity information with a low user interaction degree to the user, thereby improving the accuracy of commodity information push. The information push method may also be applied to a live broadcast information push platform to predict an interaction degree of each candidate live broadcast identifier by using an interaction live broadcast identifier sequence of a user, and then select a live broadcast identifier having a maximum interaction degree to push corresponding live broadcast information, thereby improving accuracy of live broadcast information push. The information push method may also be applied to a news information push platform to predict an interaction degree of each candidate news identifier by using an interaction news identifier sequence of a user, and then select a news identifier having a maximum interaction degree to push corresponding news information, thereby improving accuracy of news information push.

In a specific embodiment, the information push method may be applied to a music playback platform. Specifically, a user may browse and play various types of pushed music by using the music playback platform. When pushing music to a terminal of the user, a server of the music play platform may obtain a music pushing request, and may obtain an interacted music sequence of the user, then invoke a deployed information push model, and input the interacted music sequence into the information push model to perform pushing prediction, to obtain an interaction degree corresponding to each outputted candidate music identifier. Then, the server may select, according to a descending order of the interaction degrees, a to-be-pushed quantity of candidate music identifiers, and push music corresponding to the selected candidate music identifiers to the music playback platform in the terminal of the user. In this case, the user may play the pushed music by using the music playback platform. That is, by pushing music with a relatively high user interaction possibility, the user may be provided with a possibility of playing the pushed music, so that a conversion rate of the pushed music may be improved, and pushing of music with a low user playing possibility is reduced, thereby saving pushing resources.

Although the operations are shown sequentially according to the instructions of the arrows in the flowcharts of the foregoing embodiments, the operations are not necessarily performed sequentially according to the sequence instructed by the arrows. Unless otherwise explicitly specified in the present disclosure, the sequence of the operations is not strictly limited, and the operations may be performed in other sequences. In addition, at least some operations in the flowcharts involved in the foregoing embodiments may include a plurality of operations or a plurality of stages, and the operations or stages are not necessarily performed at a same moment, and may be performed at different moments. The operations or stages are not necessarily performed in sequence, and may be performed in turns or alternately with other operations, or at least a part of operations or stages in the other operations.

Based on the same inventive concept, an embodiment of the present disclosure further provides an information push apparatus configured to implement the foregoing information push method. Implementation solutions provided by the apparatus are similar to the implementation solutions described in the foregoing method. Therefore, for specific definitions in one or more embodiments of the information push apparatus provided below, refer to the definitions in the information push method in the foregoing descriptions. Details are not described herein.

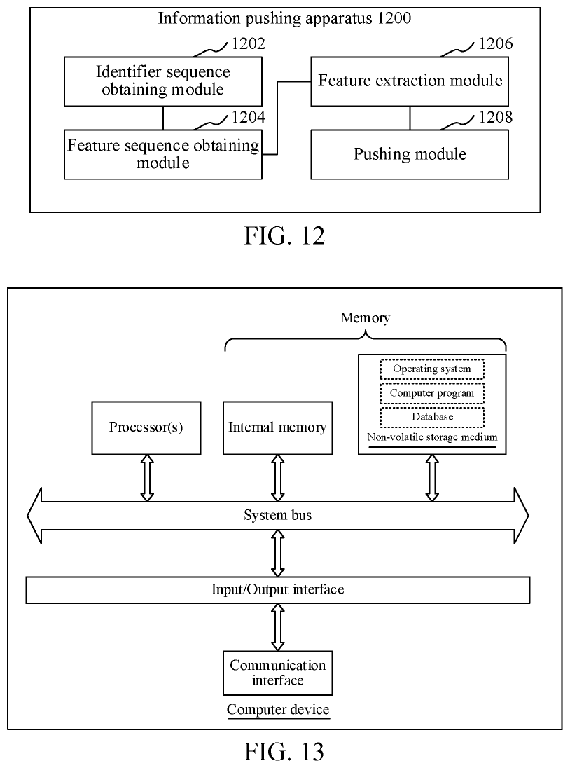

In an embodiment, as shown in FIG. 12, an information push apparatus 1200 is provided, including: an identifier sequence obtaining module 1202, a feature sequence obtaining module 1204, a feature extraction module 1206, and a pushing module 1208, where

the identifier sequence obtaining module 1202 is configured to obtain an interaction item identifier sequence, the interaction item identifier sequence including interaction item identifiers of a user;

the feature sequence obtaining module 1204 is configured to obtain an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong;

the feature extraction module 1206 is configured to fuse the interaction item feature sequence and the interaction behavior feature sequence to obtain a fused feature sequence, and extract autocorrelation information of fused features in the fused feature sequence to obtain an autocorrelation feature sequence; and

the pushing module 1208 is configured to identify, from pieces of preset scenario feature enhancement information, at least two pieces of scenario feature enhancement information corresponding to the autocorrelation feature sequence, and perform feature enhancement on the autocorrelation feature sequence based on the at least two pieces of scenario feature enhancement information to obtain an enhanced feature sequence, the enhanced feature sequence being configured for predicting interaction degrees respectively corresponding to preset candidate item identifiers, and performing item information push based on the interaction degrees respectively corresponding to the preset candidate item identifiers.

In an embodiment, the feature sequence obtaining module 1204 is further configured to: search pre-extracted interaction item features for interaction item features respectively corresponding to the interaction item identifiers, to obtain the interaction item feature sequence; obtain, from at least two interaction scenarios to which the interaction item identifiers belong, at least two pieces of interaction behavior information respectively corresponding to the interaction item identifiers; and extract embedding representations of the at least two pieces of interaction behavior information for each interaction item identifier, to obtain at least two behavior representations, fuse the at least two behavior representations to obtain an interaction behavior feature of each interaction item identifier, and obtain the interaction behavior feature sequence based on the interaction behavior feature of each interaction item identifier.

In an embodiment, the feature extraction module 1206 is further configured to fuse interaction item features in the interaction item feature sequence and corresponding interaction behavior features in the interaction behavior feature sequence, to obtain the fused feature sequence.

In an embodiment, the feature extraction module 1206 is further configured to: perform linear transformation on the fused feature sequence, to obtain a target query sequence, a target key sequence, and a target value sequence; and calculate a correlation degree between the target query sequence and the target key sequence, to obtain a correlation degree sequence, and transform the target value sequence based on the correlation degree sequence, to obtain the autocorrelation feature sequence.

In an embodiment, the pushing module 1208 is further configured to: perform information selection calculation based on the autocorrelation feature sequence, to obtain selection degrees corresponding to the pieces of preset scenario feature enhancement information; screen the pieces of preset scenario feature enhancement information based on the selection degrees corresponding to the pieces of preset scenario feature enhancement information, to obtain at least two pieces of scenario feature enhancement information corresponding to the autocorrelation feature sequence; perform feature enhancement on the autocorrelation feature sequence based on each of the at least two pieces of scenario feature enhancement information, to obtain at least two current enhanced feature sequences; and fuse the at least two current enhanced feature sequences according to the selection degrees respectively corresponding to the at least two pieces of scenario feature enhancement information, to obtain the enhanced feature sequence.

In an embodiment, the pushing module 1208 is further configured to: obtain an information quantity of the at least two pieces of scenario feature enhancement information, and updating, based on the information quantity, the selection degrees corresponding to the pieces of preset scenario feature enhancement information, to obtain update degrees corresponding to the pieces of preset scenario feature enhancement information; normalize the update degrees corresponding to the pieces of preset scenario feature enhancement information, to obtain target selection degrees corresponding to the pieces of preset scenario feature enhancement information; determine target selection degrees respectively corresponding to the at least two pieces of scenario feature enhancement information from the target selection degrees respectively corresponding to the pieces of preset scenario feature enhancement information; and fuse the at least two current enhanced feature sequences according to the target selection degrees respectively corresponding to the at least two pieces of scenario feature enhancement information, to obtain the enhanced feature sequence.

In an embodiment, the pushing module 1208 is further configured to: determine, based on the information quantity, first selection degrees and second selection degrees from the selection degrees corresponding to the pieces of preset scenario feature enhancement information, the first selection degrees being all greater than the second selection degrees, and a quantity of the first selection degrees being the same as the information quantity; and keep the first selection degrees unchanged, and update the second selection degrees to a preset target value, to obtain update degrees corresponding to the pieces of preset scenario feature enhancement information.

In an embodiment, the pushing module 1208 is further configured to: weight, for each piece of scenario feature enhancement information, a corresponding current enhanced feature sequence according to a target selection degree, to obtain each weighted feature sequence; and fuse the weighted feature sequences, to obtain the enhanced feature sequence.

In an embodiment, the information push apparatus 1200 further includes:

a depth feature extraction module, configured to: use the enhanced feature sequence as the fused feature sequence, and return to iteratively perform the operation of extracting autocorrelation information of fused features in the fused feature sequence to obtain an autocorrelation feature sequence, until a depth enhancement completion condition is satisfied, to obtain a depth enhanced feature sequence, the depth enhanced feature sequence being configured for predicting depth interaction degrees respectively corresponding to preset candidate item identifiers, and perform item information push based on the depth interaction degrees respectively corresponding to the preset candidate item identifiers.

In an embodiment, the information push apparatus 1200 further includes:

an item information push module, configured to: perform linear transformation on the enhanced feature sequence based on the preset candidate item identifiers, to obtain linear transformation features respectively corresponding to the preset candidate item identifiers; perform interaction degree mapping on the linear transformation features respectively corresponding to the preset candidate item identifiers, to obtain the interaction degrees respectively corresponding to the preset candidate item identifiers; screen the preset candidate item identifiers based on the interaction degrees respectively corresponding to the preset candidate item identifiers, to obtain a target item identifier; and push item information of the target item identifier.

In an embodiment, the information push apparatus 1200 further includes:

a model pushing module, configured to: input the interaction item identifier sequence into an information push model, the information push model including a feature extraction network, an autocorrelation feature extraction network, a feature enhancement network, and an information push network; obtain, by using the feature extraction network, an interaction item feature sequence and an interaction behavior feature sequence that correspond to the interaction item identifier sequence, and fusing the interaction item feature sequence and the interaction behavior feature sequence, to obtain a fused feature sequence; extract, by using the autocorrelation feature extraction network, autocorrelation information of fused features in the fused feature sequence to obtain an autocorrelation feature sequence; identify, by using the feature enhancement network from pieces of preset scenario feature enhancement information, at least two pieces of scenario feature enhancement information corresponding to the autocorrelation feature sequence, and perform feature enhancement on the autocorrelation feature sequence based on the at least two pieces of scenario feature enhancement information to obtain an enhanced feature sequence; and predict, by using the information push network, interaction degrees respectively corresponding to preset candidate item identifiers based on the enhanced feature sequence, and perform item information push based on the interaction degrees respectively corresponding to the preset candidate item identifiers.

In an embodiment, the information push apparatus 1200 further includes:

a model training module, configured to: obtain a historical interaction item identifier sequence, and determine a training interaction item identifier sequence and an item identifier training label based on the historical interaction item identifier sequence; input the training interaction item identifier sequence into an initial information push model, to obtain training interaction degrees respectively corresponding to outputted training candidate item identifiers; perform loss calculation based on the training interaction degrees respectively corresponding to the training candidate item identifiers and the item identifier training label, to obtain loss information; and train the initial information push model based on the loss information, and obtain the information push model when a training completion condition is satisfied.

In an embodiment, the interaction item identifier sequence includes an interaction video identifier sequence, the interaction video identifier sequence includes interaction video identifiers of the user, the preset candidate item identifiers include preset candidate video identifiers, and the information push apparatus 1200 further includes:

a video pushing module, configured to: obtain an enhanced feature sequence corresponding to the interaction video identifier sequence, and predict, based on the enhanced feature sequence corresponding to the interaction video identifier sequence, interaction degrees respectively corresponding to the preset candidate video identifiers; screen the preset candidate video identifiers based on the interaction degrees respectively corresponding to the preset candidate video identifiers, to obtain a target video identifier; and push video information of the target video identifier.

The modules in the foregoing information push apparatus may be implemented in whole or in part by software, hardware, and a combination thereof. The foregoing modules may be built in or independent of a processor of a computer device in a form of hardware, or may be stored in a memory of the computer device in a form of software, for the processor to invoke to perform operations corresponding to the foregoing modules.

In an embodiment, a computer device is provided. The computer device may be a server, and an internal structure diagram thereof may be shown in FIG. 13. The computer device includes a processor, a memory, an Input/Output (I/O) interface, and a communications interface. The processor, the memory, and the I/O interface are connected via a system bus, and the communication interface is connected to the system bus via the I/O interface. The processor of the computer device is configured to provide computing and control capabilities. The memory of the computer device includes a non-volatile storage medium and an internal memory. The nonvolatile storage medium has an operating system, a computer program, and a database stored therein. The internal memory provides a running environment for the operating system and the computer program on the non-volatile storage medium. The database of the computer device is configured to store data such as an interaction item identifier sequence, item information of each interaction item identifier, interaction behavior information of each interaction item identifier, an interaction behavior feature sequence, and an interaction scenario to which an interaction item identifier belongs. The input/output interface of the computer device is configured for exchanging information between the processor and an external device. The communication interface of the computer device is configured to communicate with an external terminal through a network. The computer program, when executed by the processor, implements an information push method.

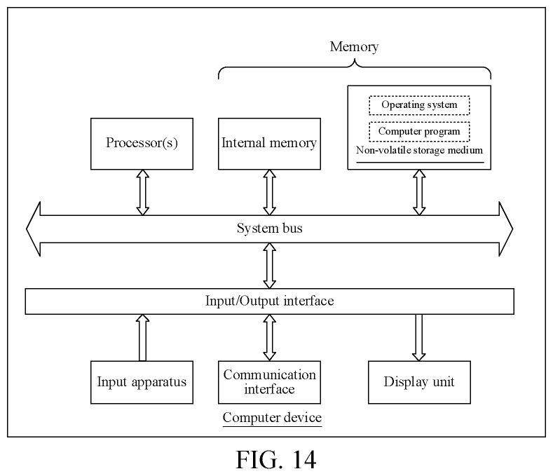

In an embodiment, a computer device is provided. The computer device may be a terminal, and an internal structure diagram thereof may be shown in FIG. 14. The computer device includes a processor, a memory, an input/output (I/O) interface, a communication interface, a display unit, and an input apparatus. The processor, the memory, and the I/O interface are connected through a system bus, and the communication interface, the display unit, and the input apparatus are connected to the system bus through the I/O interface. The processor of the computer device is configured to provide computing and control capabilities. The memory of the computer device includes a non-volatile storage medium and an internal memory. The non-volatile storage medium has an operating system and a computer program stored thereon. The internal memory provides a running environment for the operating system and the computer program on the non-volatile storage medium. The input/output interface of the computer device is configured for exchanging information between the processor and an external device. The communication interface of the computer device is configured for wired or wireless communication with an external terminal. The wireless communication may be realized through Wi-Fi, a mobile cellular network, near-field communication (NFC), or other technologies. The computer program, when executed by the processor, implements an information push method. The display unit of the computer device is configured to form a visual picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse, or the like.

A person skilled in the art may understand that the structure shown in FIG. 13 or FIG. 14 is merely a block diagram of a partial structure related to the solutions of the present disclosure, and does not constitute a limitation on the computer device to which the solutions of the present disclosure are applied. Specifically, the computer device may include more or fewer components than those shown in the figure, have some components combined, or have a different component arrangement.

In an embodiment, a computer device is provided, including a memory and a processor, the memory storing a computer program, the processor, when executing the computer program, implementing the operations in the foregoing method embodiments.

In an embodiment, a computer-readable storage medium is provided, having a computer program stored thereon. The computer program, when executed by a processor, implements operations in the foregoing method embodiments.

In an embodiment, a computer program product is provided, including a computer program. The computer program, when executed by a processor, implements operations in the foregoing method embodiments.

In the disclosed information push method and apparatus, computer device, storage medium, and computer program product, by obtaining an interaction item identifier sequence, the interaction item identifier sequence including interaction item identifiers of a user; fusing the interaction item feature sequence and the interaction behavior feature sequence to obtain a fused feature sequence, and extracting autocorrelation information of fused features in the fused feature sequence to obtain an autocorrelation feature sequence; and identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence, that is, by performing feature enhancement on the autocorrelation feature sequence by using a plurality of pieces of scenario feature enhancement information, item information and interaction behavior information of an interaction scenario can be better fit, thereby improving accuracy of the obtained enhanced feature sequence. Then, the enhanced feature sequence can be configured for predicting interaction degrees respectively corresponding to preset candidate item identifiers, and performing item information push based on the interaction degrees respectively corresponding to the preset candidate item identifiers, that is, the enhanced feature sequence with high accuracy is configured for performing prediction and perform information push, thereby improving information push accuracy. That is, pushing of item information with a low interaction degree can be reduced, thereby saving pushing resources.

User information (including but not limited to user equipment information, user personal information, and the like) and data (including but not limited to data for analysis, stored data, presented data, and the like) involved in the present disclosure are all authorized by users or fully authorized by all parties, and collection, use, and processing of relevant data need to comply with relevant laws, regulations, and standards of relevant countries and regions.

A person of ordinary skill in the art may understand that all or some of procedures of the method in the foregoing embodiments may be implemented by instructing relevant hardware by using a computer program. The computer program may be stored in a non-volatile computer-readable storage medium. When the computer program is executed, the procedures of the foregoing method embodiments may be included. Any reference to a memory, a database, or another medium used in the various embodiments provided by the present disclosure may include at least one of non-volatile and volatile memories. The non-volatile memory may include a Read-Only Memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, or the like. As an illustration rather than a limitation, the RAM is available in various forms, such as a static random-access memory (SRAM) and a dynamic random-access memory (DRAM). A database involved in the embodiments provided in the present disclosure may include at least one of a relational database and a non-relational database. The non-relational database may include, but is not limited to, a blockchain-based distributed database, or the like. A processor involved in the embodiments provided in the present disclosure may be, but is not limited to, a general-purpose processor, a central processing unit, a graphics processing unit, a digital signal processor, a programmable logic device, a quantum computing-based data processing logic device, or the like.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this description provided that no conflict exists.

The foregoing embodiments only show several implementations of the present disclosure and are described in detail, but they are not to be construed as a limit to the patent scope of the present disclosure. For those of ordinary skill in the art, several transformations and improvements may further be made without departing from the idea of the present disclosure. These transformations and improvements fall within the scope of protection of the present disclosure. Therefore, the protection scope of the present disclosure is subject to the protection scope of the appended claims.

What is claimed is:

1. An information push method, comprising:
obtaining an interaction item identifier sequence, the interaction item identifier sequence comprising interaction item identifiers of a user;
obtaining an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong;
fusing the interaction item feature sequence and the interaction behavior feature sequence to obtain a fused feature sequence, and extracting autocorrelation information of fused features in the fused feature sequence to obtain an autocorrelation feature sequence; and
identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence,
the enhanced feature sequence being configured for predicting interaction degrees respectively corresponding to preset candidate item identifiers, and performing item information push based on the interaction degrees respectively corresponding to the preset candidate item identifiers.

2. The method according to claim 1, wherein obtaining the interaction item feature sequence and the interaction behavior feature sequence based on the interaction item identifier sequence comprises:
searching pre-extracted interaction item features for interaction item features respectively corresponding to the interaction item identifiers, to obtain the interaction item feature sequence;
obtaining, from at least two interaction scenarios to which the interaction item identifiers belong, at least two pieces of interaction behavior information respectively corresponding to the interaction item identifiers; and
extracting embedding representations of the at least two pieces of interaction behavior information for each interaction item identifier, to obtain at least two behavior representations, fusing the at least two behavior representations to obtain an interaction behavior feature of each interaction item identifier, and obtaining the interaction behavior feature sequence based on the interaction behavior feature of each interaction item identifier.

3. The method according to claim 1, wherein fusing the interaction item feature sequence and the interaction behavior feature sequence to obtain the fused feature sequence comprises:
fusing interaction item features in the interaction item feature sequence and corresponding interaction behavior features in the interaction behavior feature sequence, to obtain the fused feature sequence.

4. The method according to claim 1, wherein extracting the autocorrelation information of fused features in the fused feature sequence to obtain the autocorrelation feature sequence comprises:
performing linear transformation on the fused feature sequence, to obtain a target query sequence, a target key sequence, and a target value sequence; and
calculating a correlation degree between the target query sequence and the target key sequence, to obtain a correlation degree sequence, and transforming the target value sequence based on the correlation degree sequence, to obtain the autocorrelation feature sequence.

5. The method according to claim 1, wherein identifying, from the pieces of preset scenario feature enhancement information, the at least two pieces of scenario feature enhancement information corresponding to the autocorrelation feature sequence, and performing the feature enhancement on the autocorrelation feature sequence based on the at least two pieces of scenario feature enhancement information to obtain the enhanced feature sequence comprises:
performing information selection calculation based on the autocorrelation feature sequence, to obtain selection degrees corresponding to the pieces of preset scenario feature enhancement information;
screening the pieces of preset scenario feature enhancement information based on the selection degrees corresponding to the pieces of preset scenario feature enhancement information, to obtain at least two pieces of scenario feature enhancement information corresponding to the autocorrelation feature sequence;
performing feature enhancement on the autocorrelation feature sequence based on each of the at least two pieces of scenario feature enhancement information, to obtain at least two current enhanced feature sequences; and
fusing the at least two current enhanced feature sequences according to the selection degrees respectively corresponding to the at least two pieces of scenario feature enhancement information, to obtain the enhanced feature sequence.

6. The method according to claim 5, wherein fusing the at least two current enhanced feature sequences according to the selection degrees respectively corresponding to the at least two pieces of scenario feature enhancement information, to obtain the enhanced feature sequence comprises:
obtaining an information quantity of the at least two pieces of scenario feature enhancement information, and updating, based on the information quantity, the selection degrees corresponding to the pieces of preset scenario feature enhancement information, to obtain update degrees corresponding to the pieces of preset scenario feature enhancement information;
normalizing the update degrees corresponding to the pieces of preset scenario feature enhancement information, to obtain target selection degrees corresponding to the pieces of preset scenario feature enhancement information;
determining target selection degrees respectively corresponding to the at least two pieces of scenario feature enhancement information from the target selection degrees respectively corresponding to the pieces of preset scenario feature enhancement information; and
fusing the at least two current enhanced feature sequences according to the target selection degrees respectively corresponding to the at least two pieces of scenario feature enhancement information, to obtain the enhanced feature sequence.

7. The method according to claim 6, wherein updating, based on the information quantity, the selection degrees corresponding to the pieces of preset scenario feature enhancement information, to obtain the update degrees corresponding to the pieces of preset scenario feature enhancement information comprises:
determining, based on the information quantity, first selection degrees and second selection degrees from the selection degrees corresponding to the pieces of preset scenario feature enhancement information, the first selection degrees being all greater than the second selection degrees, and a quantity of the first selection degrees being the same as the information quantity; and
keeping the first selection degrees unchanged, and updating the second selection degrees to a preset target value, to obtain update degrees corresponding to the pieces of preset scenario feature enhancement information.

8. The method according to claim 6, wherein fusing the at least two current enhanced feature sequences according to the target selection degrees respectively corresponding to the at least two pieces of scenario feature enhancement information, to obtain the enhanced feature sequence comprises:
weighting, for each piece of scenario feature enhancement information, a corresponding current enhanced feature sequence according to a target selection degree, to obtain each weighted feature sequence; and
fusing the weighted feature sequences, to obtain the enhanced feature sequence.

9. The method according to claim 1, further comprising:
using the enhanced feature sequence as the fused feature sequence, and returning to iteratively perform the operation of extracting autocorrelation information of fused features in the fused feature sequence to obtain an autocorrelation feature sequence, until a depth enhancement completion condition is satisfied, to obtain a depth enhanced feature sequence,
the depth enhanced feature sequence being configured for predicting depth interaction degrees respectively corresponding to preset candidate item identifiers, and performing item information push based on the depth interaction degrees respectively corresponding to the preset candidate item identifiers.

10. The method according to claim 1, further comprising:
performing linear transformation on the enhanced feature sequence based on the preset candidate item identifiers, to obtain linear transformation features respectively corresponding to the preset candidate item identifiers;
performing interaction degree mapping on the linear transformation features respectively corresponding to the preset candidate item identifiers, to obtain the interaction degrees respectively corresponding to the preset candidate item identifiers;
screening the preset candidate item identifiers based on the interaction degrees respectively corresponding to the preset candidate item identifiers, to obtain a target item identifier; and
pushing item information of the target item identifier.

11. The method according to claim 1, further comprising:
inputting the interaction item identifier sequence into an information push model, the information push model comprising a feature extraction network, an autocorrelation feature extraction network, a feature enhancement network, and an information push network;
obtaining, by using the feature extraction network, an interaction item feature sequence and an interaction behavior feature sequence that correspond to the interaction item identifier sequence, and fusing the interaction item feature sequence and the interaction behavior feature sequence, to obtain a fused feature sequence;
extracting, by using the autocorrelation feature extraction network, autocorrelation information of fused features in the fused feature sequence to obtain an autocorrelation feature sequence;
identifying, by using the feature enhancement network from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence; and
predicting, by using the information push network, interaction degrees respectively corresponding to preset candidate item identifiers based on the enhanced feature sequence, and performing item information push based on the interaction degrees respectively corresponding to the preset candidate item identifiers.

12. The method according to claim 11, wherein the information push model is trained by performing:
obtaining a historical interaction item identifier sequence, and determining a training interaction item identifier sequence and an item identifier training label based on the historical interaction item identifier sequence;
inputting the training interaction item identifier sequence into an initial information push model, to obtain training interaction degrees respectively corresponding to outputted training candidate item identifiers;
performing loss calculation based on the training interaction degrees respectively corresponding to the training candidate item identifiers and the item identifier training label, to obtain loss information; and
training the initial information push model based on the loss information, and obtaining the information push model when a training completion condition is satisfied.

13. The method according to claim 12, wherein the interaction item identifier sequence comprises an interaction video identifier sequence, the interaction video identifier sequence comprises interaction video identifiers of the user, the preset candidate item identifiers comprise preset candidate video identifiers, and the method further comprises:
obtaining an enhanced feature sequence corresponding to the interaction video identifier sequence, and predicting, based on the enhanced feature sequence corresponding to the interaction video identifier sequence, interaction degrees respectively corresponding to the preset candidate video identifiers;
screening the preset candidate video identifiers based on the interaction degrees respectively corresponding to the preset candidate video identifiers, to obtain a target video identifier; and
pushing video information of the target video identifier.

14. A computer device comprising one or more processors and a memory containing a computer program that, when been executed, causes the one or more processors to perform:
obtaining an interaction item identifier sequence, the interaction item identifier sequence comprising interaction item identifiers of a user;
obtaining an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong;
fusing the interaction item feature sequence and the interaction behavior feature sequence to obtain a fused feature sequence, and extracting autocorrelation information of fused features in the fused feature sequence to obtain an autocorrelation feature sequence; and
identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence,
the enhanced feature sequence being configured for predicting interaction degrees respectively corresponding to preset candidate item identifiers, and performing item information push based on the interaction degrees respectively corresponding to the preset candidate item identifiers.

15. The device according to claim 14, wherein the one or more processors are further configured to perform:
searching pre-extracted interaction item features for interaction item features respectively corresponding to the interaction item identifiers, to obtain the interaction item feature sequence;
obtaining, from at least two interaction scenarios to which the interaction item identifiers belong, at least two pieces of interaction behavior information respectively corresponding to the interaction item identifiers; and
extracting embedding representations of the at least two pieces of interaction behavior information for each interaction item identifier, to obtain at least two behavior representations, fusing the at least two behavior representations to obtain an interaction behavior feature of each interaction item identifier, and obtaining the interaction behavior feature sequence based on the interaction behavior feature of each interaction item identifier.

16. The device according to claim 14, wherein the one or more processors are further configured to perform:
fusing interaction item features in the interaction item feature sequence and corresponding interaction behavior features in the interaction behavior feature sequence, to obtain the fused feature sequence.

17. The device according to claim 14, wherein the one or more processors are further configured to perform:
performing linear transformation on the fused feature sequence, to obtain a target query sequence, a target key sequence, and a target value sequence; and
calculating a correlation degree between the target query sequence and the target key sequence, to obtain a correlation degree sequence, and transforming the target value sequence based on the correlation degree sequence, to obtain the autocorrelation feature sequence.

18. The device according to claim 14, wherein the one or more processors are further configured to perform:
performing information selection calculation based on the autocorrelation feature sequence, to obtain selection degrees corresponding to the pieces of preset scenario feature enhancement information;
screening the pieces of preset scenario feature enhancement information based on the selection degrees corresponding to the pieces of preset scenario feature enhancement information, to obtain at least two pieces of scenario feature enhancement information corresponding to the autocorrelation feature sequence;
performing feature enhancement on the autocorrelation feature sequence based on each of the at least two pieces of scenario feature enhancement information, to obtain at least two current enhanced feature sequences; and
fusing the at least two current enhanced feature sequences according to the selection degrees respectively corresponding to the at least two pieces of scenario feature enhancement information, to obtain the enhanced feature sequence.

19. The device according to claim 18, wherein the one or more processors are further configured to perform:
obtaining an information quantity of the at least two pieces of scenario feature enhancement information, and updating, based on the information quantity, the selection degrees corresponding to the pieces of preset scenario feature enhancement information, to obtain update degrees corresponding to the pieces of preset scenario feature enhancement information;
normalizing the update degrees corresponding to the pieces of preset scenario feature enhancement information, to obtain target selection degrees corresponding to the pieces of preset scenario feature enhancement information;
determining target selection degrees respectively corresponding to the at least two pieces of scenario feature enhancement information from the target selection degrees respectively corresponding to the pieces of preset scenario feature enhancement information; and
fusing the at least two current enhanced feature sequences according to the target selection degrees respectively corresponding to the at least two pieces of scenario feature enhancement information, to obtain the enhanced feature sequence.

20. A non-transitory computer-readable storage medium containing a computer program, that when been executed, causes at least one processor to perform:
obtaining an interaction item identifier sequence, the interaction item identifier sequence comprising interaction item identifiers of a user;
obtaining an interaction item feature sequence and an interaction behavior feature sequence based on the interaction item identifier sequence, the interaction item feature sequence being obtained by performing feature extraction on item information corresponding to the interaction item identifiers, the interaction behavior feature sequence being obtained by performing feature extraction on interaction behavior information corresponding to the interaction item identifiers, and the interaction behavior information being obtained from an interaction scenario to which the interaction item identifiers belong;
fusing the interaction item feature sequence and the interaction behavior feature sequence to obtain a fused feature sequence, and extracting autocorrelation information of fused features in the fused feature sequence to obtain an autocorrelation feature sequence; and
identifying, from pieces of preset scenario feature enhancement information, at least two pieces of scenario feature enhancement information corresponding to the autocorrelation feature sequence, and performing feature enhancement on the autocorrelation feature sequence based on the at least two pieces of scenario feature enhancement information to obtain an enhanced feature sequence,
the enhanced feature sequence being configured for predicting interaction degrees respectively corresponding to preset candidate item identifiers, and performing item information push based on the interaction degrees respectively corresponding to the preset candidate item identifiers.
